(19) United States
(12) Patent Application Publication
(10) Pub. No.: US 2021/0077938 A1
(43) Pub. Date: Mar. 18, 2021

(54) POWDER COLLECTOR

(71) Applicant: SEIKO EPSON CORPORATION, Tokyo (JP)

(72) Inventor: Akihiro SATAKE, Higashitagawa-gun (JP)

(21) Appl. No.: 17/020,865

(22) Filed: Sep. 15, 2020

(30) Foreign Application Priority Data
Sep. 17, 2019 (JP) 2019-168107

(51) Int. Cl. B01D 46/48; B01D 46/24; B01D 46/00; D21G 9/00

(52) U.S. Cl. CPC B01D 46/48; B01D 46/24; B01D 2273/28; B01D 46/0067; D21G 9/00; B01D 46/002

(57) ABSTRACT

A powder collector including a box including a first opening configured to pass powder therethrough, a bottom portion disposed so as to oppose the first opening, and a side portion that intersects the first opening and the bottom portion, the box being configured to install a bag provided so as to be in communication with the first opening, a second opening provided in the box, the second opening being configured to suction a gas inside the box, a plurality of frames disposed in at least either one of the bottom portion and the side portion, and a flow portion configured to flow the gas therethrough. In the powder collector, the flow portion is a gap formed between a frame among the plurality of frames and another frame among the plurality of frames.

The present application is based on, and claims priority from JP Application Serial Number 2019-168107, filed Sep. 17, 2019, the disclosure of which is hereby incorporated by reference herein in its entirety.

### BACKGROUND

### 1. Technical Field

The present disclosure relates to a powder collector.

### 2. Related Art

Hitherto, a dust collector that collects dust-like removed substances (unneeded substances) with filters is proposed (JP-A-2018-099637, for example).

The dust collector described in JP-A-2018-099637 includes a collection box in which a collection bag that accommodates dust-like unneeded substances are disposed, and a collection box blower in communication with the collection box. When the collection box blower suctions the gas inside the collection box, the pressure in the space between the collection box and the collection bag becomes negative and a pressure difference is created between the space between the collection box and the collection bag, and the internal space of the collection bag, and the collection bag becomes expanded in the collection box.

Furthermore, the unneeded substances adhered to the filter are collected in the collection bag expanded in the collection box.

However, in the dust collector described in JP-A-2018-099637, when the collection box blower suctions the gas inside the collection box to expand the collection bag, the pressure inside the collection box becomes negative and due to the pressure difference with the outside, the collection box may become deformed. Furthermore, when the suction of the gas between the collection box and the collection bag becomes uneven, the expanding of the collection bag in the collection box may become uneven.

### SUMMARY

A powder collector including a box including a first opening configured to pass powder therethrough, a bottom portion disposed so as to oppose the first opening, and a side portion that intersects the first opening and the bottom portion, the box being configured to install a bag provided so as to be in communication with the first opening, a suction opening provided in the box, the suction opening being configured to suction a gas inside the box, a plurality of frames disposed in at least either one of the bottom portion and the side portion, and a flow portion configured to flow the gas therethrough, in which the flow portion is a gap formed between a primary frame among the plurality of frames and a secondary frame among the plurality of frames.

A powder collector includes a box including a first opening configured to pass powder therethrough, a bottom portion disposed so as to oppose the first opening, and a side portion that intersects the first opening and the bottom portion, the box being configured to install a bag provided so as to be in communication with the first opening, a suction opening provided in the box, the suction opening being configured to suction a gas inside the box, a frame disposed in at least either one of the bottom portion and the side portion, in which a flow portion configured to flow the gas therethrough is formed in the frame.

In the powder collector described above, desirably, the frame includes a tertiary frame in contact with the bottom portion, and the flow portion is a groove that extends in a direction that intersects a direction in which the tertiary frame extends, the groove being formed in at least one of a first surface of the tertiary frame in contact with the bottom portion, a second surface of the tertiary frame on a side opposite the first surface, and a third surface of the tertiary frame that intersects the first surface and the second surface.

In the powder collector described above, desirably, the frame includes a quaternary frame in contact with the side portion, and the flow portion is a groove that extends in a direction that intersects a direction in which the quaternary frame extends, the groove being formed in at least one of a fourth surface of the quaternary frame in contact with the side portion, a fifth surface of the quaternary frame on a side opposite the fourth surface, and a sixth surface of the quaternary frame that intersects the fourth surface and the fifth surface.

In the powder collector described above, desirably, the flow portion is a hole that penetrates through the frame.

In the powder collector described above, desirably, the suction opening is covered by a frame of the plurality of frames, and the flow portion is a hole provided in the frame.

In the powder collector described above, desirably, the flow portion includes a first hole in communication with the suction opening, the first hole extending in a direction in which the frame extends, and a second hole in communication with the first hole, the second hole extending in a direction that intersects the direction in which the frame extends, and the gas inside the box is suctionable through the first hole and the second hole.

In the powder collector described above, desirably, the frame is in contact with the bottom portion, and the second hole is formed so as to penetrate through a third surface that intersects a first surface of the frame, the first surface being in contact with the bottom portion, and a second surface on a side opposite the first surface.

In the powder collector described above, desirably, the frame is in contact with the side portion, and the second hole is formed so as to penetrate through a sixth surface that intersects a fourth surface of the frame, the fourth surface being in contact with the side portion, and a fifth surface on a side opposite the fourth surface.

### BRIEF DESCRIPTION OF THE DRAWINGS

FIG. 1 is a schematic diagram illustrating a configuration of a sheet manufacturing system.

FIG. 2 is a schematic view illustrating an outline of a powder collector according to the present exemplary embodiment.

FIG. 3 is a schematic view illustrating a state of a box.

FIG. 4 is a plan view of an area IV surrounded by a broken line in FIG. 3.

FIG. 5 is a schematic view illustrating a state of frames of a box included in a powder collector according to a second exemplary embodiment.

FIG. 6 is a cross-sectional view of a frame taken along line VI-VI in FIG. 5.

FIG. 7 is another cross-sectional view of the frame taken along line VII-VII in FIG. 6.

FIG. 8 is a plan view of a fourth surface of the frame.

FIG. 9 is a cross-sectional view of a frame taken along line IX-IX in FIG. 5.

FIG. 10 is another cross-sectional view of the frame taken along line X-X in FIG. 9.

FIG. 11 is a plan view of a first surface of the frame.

FIG. 12 is a cross-sectional view of a frame included in a powder collector according to a third exemplary embodiment.

FIG. 13 is another cross-sectional view of the frame.

FIG. 14 is a cross-sectional view of the frame.

FIG. 15 is another cross-sectional view of the frame.

FIG. 16 is a schematic view illustrating a state of frames of a box included in a powder collector according to a fourth exemplary embodiment.

FIG. 17 is a plan view of a frame viewed in the Z direction.

FIG. 18 is a schematic view illustrating a state of frames of a box included in a powder collector according to a fifth exemplary embodiment.

FIG. 19 is a plan view of a frame viewed in the Y direction.

FIG. 20 is a plan view of the frame viewed in the X direction.

### DESCRIPTION OF EXEMPLARY EMBODIMENTS

### 1. First Exemplary Embodiment

### 1.1 Outline of Sheet Manufacturing System

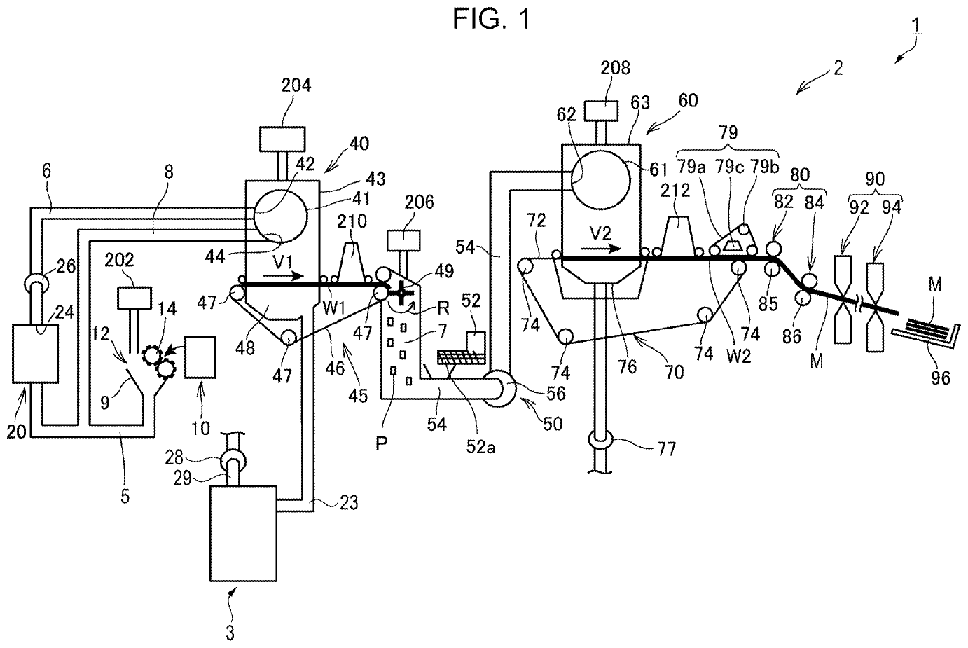

FIG. 1 is a schematic diagram illustrating a configuration of a sheet manufacturing system 1.

Referring first to FIG. 1, an outline of the sheet manufacturing system 1 will be described.

As illustrated in FIG. 1, the sheet manufacturing system 1 includes a sheet manufacturing apparatus 2 and a powder collector 3 according to a first exemplary embodiment.

The sheet manufacturing apparatus 2 is configured to manufacture a new sheet of paper (a sheet M) by performing dry defibration and fiberization on a raw material such as pieces of paper (wastepaper) containing fiber and, subsequently, by compressing, heating, and cutting the above. Furthermore, by mixing various additives to the defibrated object, which is defibrated and fiberized wastepaper, the sheet manufacturing apparatus 2 is capable of improving the bond strength or the whiteness, or adding a function such as color, aroma, or flame resistance.

The powder collector 3 according to the present exemplary embodiment collects the unneeded substance discharged from the sheet manufacturing apparatus 2.

The sheet manufacturing apparatus 2 includes a feeding portion 10, a shredding portion 12, a defibrating portion 20, a screening portion 40, a first web forming portion 45, a rotor 49, a mixing portion 50, an accumulating portion 60, a second web forming portion 70, a transport portion 79, a sheet forming portion 80, and a cutting portion 90 that are sequentially disposed along a transport path through which the raw material and the defibrated objects are transported.

Furthermore, the sheet manufacturing apparatus 2 includes humidifying portions 202, 204, 206, 208, 210, and 212 with the aim of humidifying the raw material and/or humidifying the space through which the raw material passes. The humidifying portions 202, 204, 206, and 208 are each configured of a vaporizing or a hot-air and vaporizing humidifier including a filter (not shown) that is wetted with water. By passing gas (air) through the filter, humidified gas with increased humidity is supplied. The humidifying portions 210 and 212 are each configured of an ultrasonic humidifier including a vibrating portion (not shown) that atomizes water. The humidifying portions 210 and 212 supply mist generated by the vibrating portion.

Note that the humidifying portions 202, 204, 206, 208, 210, and 212 may be of any specific configuration including that of a steam type, a vaporizing type, a hot air and vaporizing type, and an ultrasonic type.

The feeding portion 10 feeds the raw material to the shredding portion 12. The raw material with which the sheet manufacturing apparatus 2 manufactures the sheet M may be any material that contains fiber. A raw material such as, for example, paper, pulp, a pulp sheet, fabric including non-woven fabric, or woven fabric can be used as the raw material to manufacture the sheet M. The feeding portion 10 may be configured to include a stacker (not shown) that stacks and accumulates wastepaper, and an automatic feeder (not shown) that sends the wastepaper from the stacker to the shredding portion 12.

The shredding portion 12 cuts (shreds) the raw material fed from the feeding portion 10 into shredded pieces with shredding blades 14. The shredding blades 14 cut the raw material in midair such as in atmospheric air. The shredding portion 12 may be configured in a manner similar to that of a so-called shredder that includes a pair of shredding blades 14 that cut the raw material by nipping the raw material therebetween, and a driving portion (not shown) that rotates the shredding blades 14. The shape and the size of the shredded pieces may be of any shape and size that are suitable for the defibrating process in the defibrating portion 20. For example, the shredding portion 12 cuts the raw material into pieces of paper that are each one to a few square centimeters or smaller.

The shredding portion 12 includes a shoot 9 that receives the falling shredded pieces cut by the shredding blades 14. The shoot 9 has, for example, a tapered shape in which the width becomes gradually smaller in a direction in which the shredded pieces advance. A pipe 5 in communication with the defibrating portion 20 is coupled to the shoot 9. The pipe 5 forms a transport path through which the raw material (the shredded pieces) cut by the shredding blades 14 is transported to the defibrating portion 20. The shredded pieces are collected by the shoot 9, passed through the pipe 5, and are delivered to the defibrating portion 20.

Humidified gas is fed to the shoot 9 included in the shredding portion 12 or to the vicinity of the shoot 9 with the humidifying portion 202. With the above, a phenomenon in which the shredded pieces cut by the shredding blades 14 being attached to inner surfaces of the shoot 9 and the pipe 5 by static electricity can be suppressed. Furthermore, since the shredded pieces cut by the shredding blades 14 are, together with the humidified gas, delivered to the defibrating portion, an effect of suppressing the defibrated object inside the defibrating portion 20 from being attached can be expected as well.

The defibrating portion 20 defibrates the shredded pieces cut in the shredding portion 12. More specifically, the defibrating portion 20 performs the defibrating process on the shredded pieces cut by the shredding portion 12 and creates the defibrated objects. The defibrated object is a raw material such as wastepaper defibrated into fiber until the original shape is lost. The defibrating portion 20 also functions to separate, from the fibers, substances such as resin particles, ink, toner, and a blur inhibitor attached to the raw material.

An object that has passed through the defibrating portion 20 is referred to as the defibrated object. The defibrated object contains, other than the fiber of the unraveled raw material, unneeded substances (additives such as resin that bonds the fiber to each other, a coloring material such as ink and toner, a blur inhibitor, a paper strong agent, and the like) that are separated from the fiber when the raw material is unraveled.

The defibrating portion 20 performs dry defibration. The defibrating portion 20 is an impeller mill that includes a rotor (not shown) that rotates at high speed, and a liner (not shown) that is positioned at the periphery of the rotor.

The shredded pieces cut at the shredding portion 12 are defibrated by being interposed between the rotor and the liner of the defibrating portion 20. The defibrating portion 20 generates airflow with the rotation of the rotor. The defibrating portion 20 is configured to, with the airflow, suction the shredded pieces, which are the raw material, through the pipe 5 and to send out the defibrated objects through a discharge port 24 into a pipe 6. A defibrating portion blower 26 is attached to the pipe 6. The defibrated objects created in the defibrating portion 20 are delivered through the pipe 6 and to the screening portion 40 with the airflow generated by the defibrating portion blower 26.

The screening portion 40 includes an introduction port 42 through which the defibrated objects that have been defibrated by the defibrating portion 20 flow, together with the airflow, from the pipe 6. The screening portion 40 screens the defibrated objects introduced through the introduction port 42 by the length of the fiber. Specifically, the screening portion 40 screens, among the defibrated objects defibrated by the defibrating portion 20, the defibrated object that is equivalent to or smaller than a predetermined size as a first screened object and screens the defibrated object that is larger than the first screened object as a second screened object. The first screened object includes fiber, particles, or the like, and the second screened object includes, for example, a large fiber, an undefibrated piece (a shredded piece that has not been sufficiently defibrated), or a lump of aggregated or tangled defibrated fiber.

The screening portion 40 includes a drum portion 41, and a housing portion 43 that houses the drum portion 41.

The drum portion 41 is a cylindrical sieve that is rotationally driven by a motor. The drum portion 41 includes a screen (a filter) and functions as a sieve. With the screen meshes, the drum portion 41 screens the defibrated objects introduced through the introduction port 42 into a first screened object that is smaller than the size of each screen mesh opening (opening), and a second screened object that is larger than the screen mesh opening. A wire screen, an expand metal, which is an elongated metal plate with cutouts, a perforated metal in which holes are formed in a metal plate with a press machine or the like can be used as the screen of the drum portion 41.

The defibrated objects introduced through the introduction port 42 are, together with the airflow, sent into the drum portion 41, and the first screened objects fall downwards through the screen meshes of the drum portion 41 with the rotation of the drum portion 41. The second screened objects that cannot pass through the screen meshes of the drum portion 41 are made to flow and are guided to a discharge port 44 with the airflow flowing into the drum portion 41 through the introduction port 42, are sent to a pipe 8, are made to pass through the pipe 8, and are returned to the defibrating portion 20 so that the defibrating process is performed thereon once again.

The first screened objects that are to be screened by the drum portion 41 pass through the screen meshes of the drum portion 41, are scattered into the gas, and descend towards a mesh belt 46 of the first web forming portion 45 positioned below the drum portion 41.

The first web forming portion 45 includes the mesh belt 46, rollers 47, and a suction portion (a suction mechanism) 48. The mesh belt 46 is an endless belt stretched across three rollers 47 and is transported in a direction indicated by an arrow in the drawing with the movement of the rollers 47. A surface of the mesh belt 46 is configured of a screen in which openings each having a predetermined size are arranged. Among the first screened objects that descend from the screening portion 40, minute particles with sizes that pass through the screen meshes fall below the mesh belt 46, and the fibers with sizes that cannot pass through the screen meshes accumulate on the mesh belt 46 and are, together with the mesh belt 46, transported in the direction of the arrow.

The mesh belt 46 moves at a uniform velocity V1 during the operation of manufacturing the sheet M.

The minute particles that fall down from the mesh belt 46 are relatively small defibrated objects or are ones that have low density (resin particles, coloring material, additives, and the like), which are unneeded substances that are not suitable for manufacturing the sheet M. In other words, the first web forming portion 45 removes the unneeded substances, which are not suitable for manufacturing the sheet M, from the first screened objects. The remains of the first screened objects after the unneeded substances have been removed therefrom with the first web forming portion 45 are materials suitable for manufacturing the sheet M, which accumulate on the mesh belt 46 forming a first web W1.

The suction portion 48 that suctions gas from under the mesh belt 46 is provided below the mesh belt 46. The powder collector 3 and a collection blower 28 are proved below the suction portion 48. The suction portion 48 and the powder collector 3 are coupled to each other with a pipe 23, and the powder collector 3 and the collection blower 28 are coupled to each other with a pipe 29.

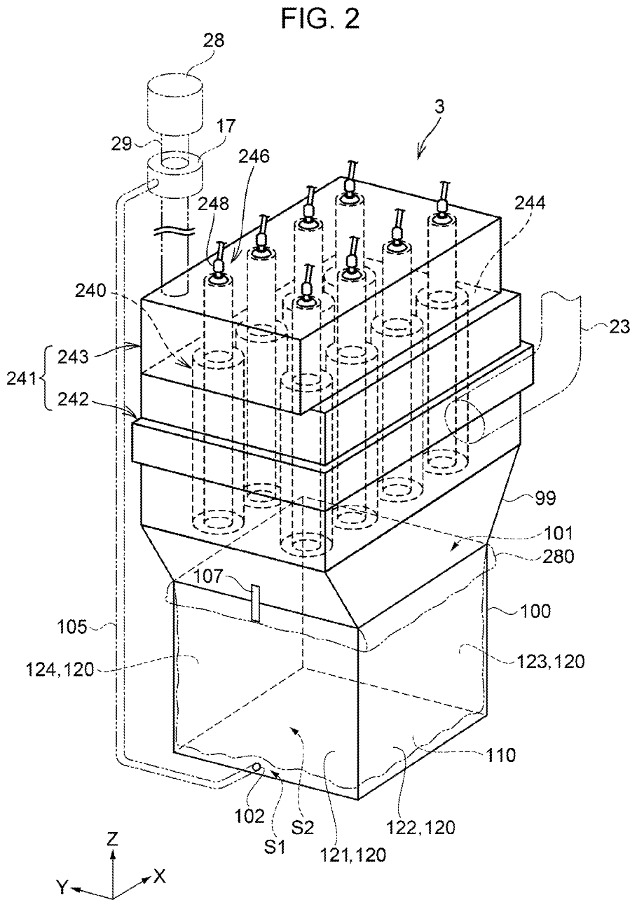

While not illustrated in FIG. 1, a switching portion 17 (see FIG. 2) is provided between the powder collector 3 and the collection blower 28.

The collection blower 28 suctions gas through the powder collector 3 and the suction portion 48. When the collection blower 28 suctions the gas through the powder collector 3 and the suction portion 48, the minute particles (the unneeded substances) that pass through the screen meshes of the mesh belt 46 are suctioned together with the gas and are sent to the powder collector 3 through the pipe 23. The powder collector 3 separates and collects the unneeded substances, which have passed through the screen meshes of the mesh belt 46, from the airflow. Furthermore, the gas discharged by the collection blower 28 is discharged to the outside of the sheet manufacturing apparatus 2 through the pipe 29.

Note that the unneeded substances (the minute particles that have passed through the screen meshes of the mesh belt 46) collected by the powder collector 3 are an example of the powder in the present application.

The accumulation of the fibers, obtained by removing the unneeded substances from the first screened objects, forms the first web W1 on the mesh belt 46. The suction performed by the collection blower 28 promotes the formation of the first web W1 on the mesh belt 46, and removes the unneeded substance in a prompt manner.

Humidified gas is fed to the space including the drum portion 41 with a humidifying portion 204. The first screened objects are humidified in the screening portion 40 with the humidified gas. With the above, attachment of the first screened objects to the mesh belt 46 with electrostatic force is weakened, which facilitates the separation of the first screened objects from the mesh belt 46. Furthermore, the above can suppress the first screened objects from, owing to electrostatic force, adhering to the rotor 49 and the inner walls of the housing portion 43. Furthermore, the unneeded substances can be suctioned in an efficient manner with the suction portion 48.

A humidifying portion 210 feeds gas including mist to a portion of the transport path in the mesh belt 46 downstream of the screening portion 40. The mist that is minute particles of water that are created by the humidifying portion 210 descends towards the first web W1 and supplies moisture to the first web W1. With the above, the amount of moisture contained in the first web W1 is controlled and attachment and the like of the fibers to the mesh belt 46 owing to static electricity is suppressed.

The rotor 49 that fragmentizes the first web W1 accumulated on the mesh belt 46 is provided downstream of the mesh belt 46 in the transport direction of the first web W1. The first web W1 is separated from the mesh belt 46 and is fragmentized by the rotor 49 at the position where the mesh belt 46 is turned back with the roller 47.

The first web W1 is a soft material formed into a web shape with the accumulation of the fibers. The rotor 49 disentangles the fibers of the first web W1 and processes the first web W1 so that resin can be easily mixed therewith at the mixing portion 50 described later.

While the configuration of the rotor 49 is optional, in the present exemplary embodiment, the rotor 49 has a rotary blade shape in which a plate-shaped blades rotate. The rotor 49 is disposed at a position that comes into contact with the first web W1 separating from the mesh belt 46. With the rotation of the rotor 49 (for example, the rotation in a direction indicated by an arrow R in the drawing), the first web W1 that is separated from the mesh belt 46 and that is transported impinges on the blades of the rotor 49, is fragmentized so that fragmented particles P are created.

The rotor 49 is, desirably, installed at a position where the blades of the rotor 49 do not collide with the mesh belt 46. For example, by setting the distance between the distal ends of the blades of the rotor 49 and the mesh belt 46 within the range of 0.05 mm to 0.5 mm, inclusive, the rotor 49 can fragmentize the first web W1 efficiently without damaging the mesh belt 46.

The fragmented particles P fragmentized by the rotor 49 descend inside a pipe 7 and are sent to the mixing portion 50 with the airflow inside the pipe 7.

Furthermore, humidified gas is fed to the space including the rotor 49 with a humidifying portion 206. With the above, a phenomenon in which the fibers are attached to the inside of the pipe 7 and to the blades of the rotor 49 by static electricity can be suppressed. Furthermore, since gas with high humidity is fed to the mixing portion 50 through the pipe 7, adverse effects caused by static electricity can be suppressed in the mixing portion 50 as well.

The mixing portion 50 includes an additive feeding portion 52 that feeds an additive containing resin, a pipe 54 that is in communication with the pipe 7 and through which an airflow containing fragmented particles P flows, and a mixing blower 56. As described above, the fragmented particles P are fibers obtained by removing the unneeded substances from the first screened objects. The mixing portion 50 mixes an additive containing resin to the fibers constituting the fragmented particles P.

Note that while the details will be described later, the sheet M is manufactured by performing at least either one of compressing and heating on a mixture (a second web W2) of the fibers constituting the fragmented particles P and the resin. In order to stabilize the quality of the sheet M, it is important to control the mixture ratio between the fibers constituting the fragmented particle P and the resin to a constant ratio.

Airflow is generated in the mixing portion 50 with the mixing blower 56, and the fragmented particles P are transported through the pipe 54 while being mixed with the additive. The fragmented particles P become disentangled and become more fibrous while flowing through the pipe 7 and the pipe 54.

The additive feeding portion 52 is coupled to an additive cartridge (not shown) that accumulates the additive therein and feeds the additive inside the additive cartridge to the pipe 54. The additive feeding portion 52 temporarily stores the additive formed of fine powder or minute particles inside the additive cartridge. The additive feeding portion 52 includes a discharge portion 52a that sends the temporarily stored additive to the pipe 54.

The discharge portion 52a includes a feeder (not shown) that sends out the additive stored in the additive feeding portion 52 to the pipe 54, and a shutter (not shown) that opens/closes the pipe line that couples the feeder and the pipe 54 to each other. When the shutter is closed, the pipe line coupling the discharge portion 52a and the pipe 54 to each other is closed, and feeding of the additive from the additive feeding portion 52 to the pipe 54 is cut off.

The additive fed by the additive feeding portion 52 contains resin to bind the plurality of fibers to each other. The resin contained in the additive is a thermoplastic resin or a thermosetting resin including, for example, AS resin, ABS resin, polypropylene, polyethylene, polyvinyl chloride, polystyrene, acryl resin, polyester resin, polyethylene terephthalate, polyphenylene ether, polybutylene terephthalate, nylon, polyamide, polycarbonate, polyacetal, polyphenylene sulfide, and polyetheretherketone. The above resins may be used alone or in mixtures as appropriate. In other words, the additive may contain a single substance or may be a mixture, or may contain a plurality of types of particles each configured of a single or a plurality of substances. Furthermore, the additive may be fibrous or may be powdery.

The resin included in the additive is melted by heat and binds a plurality of fibers to each other. Accordingly, while the fibers and the resin are in a mixed state, when the resin is not heated to the melting temperature, the fibers are not bound to each other.

Note that other than the resin that binds the fibers to each other, the additive fed to the additive feeding portion 52 may contain, according to the type of sheet that is manufactured, a coloring agent that colors the fibers, an aggregation inhibitor that inhibits the fibers from becoming aggregated or the resin from becoming aggregated, or a flame retardant that impedes the fibers and the like from burning. Furthermore, the additive that does not contain a coloring agent may be colorless, may be colorless to a degree deeming the additive as colorless, or may be white.

The fragmented particles P descending the pipe 7 with the airflow generated by the mixing blower 56, and the additive fed from the additive feeding portion 52 are suctioned into the pipe 54 and are passed through the mixing blower 56. Due to the airflow generated by the mixing blower 56 and\or the action of the rotating portion of the blades and the like included in the mixing blower 56, the fibers constituting the fragmented particles P and the additive are mixed together, are passed through the pipe 54, and are sent to an accumulating portion 60.

The mixture that has passed through the mixing portion 50 is introduced into the accumulating portion 60 through an introduction port 62. The accumulating portion 60 disentangles the entangled fibers and while allowing the fibers to fall, scatters the fibers into the gas. Furthermore, when the resin in the additive fed from the additive feeding portion 52 is fibrous, the accumulating portion 60 disentangles the entangled fibrous resin. With the above, the accumulating portion 60 can accumulate the mixture on the second web forming portion 70 in a uniform manner.

The second web forming portion 70 is disposed below the drum portion 61. The second web forming portion 70 accumulates the mixture that has passed through the accumulating portion 60 and forms the second web W2. The second web forming portion 70 includes, for example, a mesh belt 72, rollers 74, and a suction mechanism 76.

The mesh belt 72 is an endless belt stretched across a plurality of rollers 74 and is transported in a direction indicated by an arrow in the drawing with the movement of the rollers 74. The mesh belt 72 is, for example, made of metal, resin, fabric, or non-woven fabric. A surface of the mesh belt 72 is configured of a screen in which openings each having a predetermined size are arranged. Among the fibers and particles that descend from the drum portion 61, minute particles with sizes that pass through the screen meshes fall below the mesh belt 72, and the fibers with sizes that cannot pass through the screen meshes accumulate on the mesh belt 72 and are, together with the mesh belt 72, transported in the direction of the arrow.

The mesh belt 72 moves at a uniform velocity V2 during the operation of manufacturing the sheet M.

The screen meshes of the mesh belt 72 are fine meshes and may be of sizes that do not allow most of the fibers and particles that descend from the drum portion 61 to pass therethrough.

The suction mechanism 76 is provided under the mesh belt 72. The suction mechanism 76 includes a suction blower 77. Airflow from the accumulating portion 60 towards the mesh belt 72 is generated by suction force of the suction blower 77.

The mixture that has been scattered in the gas with the accumulating portion 60 is suctioned onto the mesh belt 72 with the suction mechanism 76. With the above, the formation of the second web W2 on the mesh belt 72 is promoted and a discharge speed from the accumulating portion 60 can be increased. Furthermore, the suction mechanism 76 can form a downflow in the falling route of the mixture, and entangling of the defibrated objects and the additive while falling can be prevented.

The suction blower 77 discharges the gas suctioned through the suction mechanism 76 to the outside of the sheet manufacturing apparatus 2 through a collecting filter (not shown). Note that the gas suctioned by the suction blower 77 may be sent to the powder collector 3, and the powder collector 3 may collect the unneeded substances included in the gas suctioned by the suction mechanism 76.

Humidified gas is fed to the space including the drum portion 61 with a humidifying portion 208. The humidified gas allows the inside of the accumulating portion 60 to become humidified, suppresses the attachment of the fibers and particles to a housing portion 63 due to electrostatic force, promptly descends the fibers and particles onto the mesh belt 72, and allows the second web W2 having a desirable shape to be formed.

As described above, by passing through the accumulating portion 60 and the second web forming portion 70, the second web W2 that contains a lot of gas and that is in a soft and swollen state is formed. Subsequently, the second web W2 accumulated on the mesh belt 72 is transported to the sheet forming portion 80.

A humidifying portion 212 feeds gas including mist to a portion of the transport path in the mesh belt 72 downstream of the accumulating portion 60. With the above, the mist created by the humidifying portion 212 is supplied to the second web W2, and the amount of moisture contained in the second web W2 is controlled. Furthermore, attachment and the like of the fibers to the mesh belt 72 owing to static electricity are suppressed.

Furthermore, the transport portion 79 that sends out the second web W2 on the mesh belt 72 to the sheet forming portion 80 is provided downstream in the transport path of the mesh belt 72. The transport portion 79 includes, for example, a mesh belt 79a, rollers 79b, and a suction mechanism 79c.

The suction mechanism 79c includes a blower (not shown). An upwards airflow is generated in the mesh belt 79a with suction force of the blower. The airflow suctions the second web W2, and the second web W2 separated from the mesh belt 72 is attached to the mesh belt 79a. The mesh belt 79a moved by the rotation of the rollers 79b sends out the second web W2 to the sheet forming portion 80. For example, the moving speed of the mesh belt 72 and the moving speed of the mesh belt 79a are the same.

As described above, the transport portion 79 peels the second web W2 formed on the mesh belt 72 from the mesh belt 72 and sends the second web W2 to the sheet forming portion 80.

The sheet forming portion 80 forms the sheet M from the accumulated object (the second web W2) accumulated in the accumulating portion 60. Specifically, the sheet forming portion 80 forms the sheet M by compressing and heating the second web W2 sent out from the transport portion 79. By applying heat to the fibers and the additive contained in the second web W2, the sheet forming portion 80 binds the plurality of fibers in the mixture to each other through the additive (resin).

The sheet forming portion 80 includes a compressing portion 82 that compresses the second web W2, and a heating portion 84 that heats the second web W2 compressed by the compressing portion 82.

The compressing portion 82 is constituted of a pair of calender rollers 85 and compresses the second web W2 by nipping the second web W2 at a predetermined nip pressure. By being compressed, the second web W2 becomes small in thickness, and the density of the second web W2 is increased. One of the pairs of calender rollers 85 is a driving roller that is driven by a motor (not shown), and the other is a driven roller that is driven and rotated by the driving roller. The calender rollers 85 are rotated by driving force of the motor. The calender rollers 85 compress the second web W2 and transport the second web W2, which has become high in density by compression, towards the heating portion 84.

The heating portion 84 is configured of, for example, heating rollers, a hot press forming apparatus, a hot plate, a hot air blower, an infrared heater, or a flash fuser. In the present exemplary embodiment, the heating portion 84 includes a pair of heating rollers 86. The heating rollers 86 are heated to a preset temperature with an externally or internally installed heater. The heating rollers 86 nip and heat the second web W2, which has been compressed by the calender rollers 85, to form the sheet M. Furthermore, one of the pairs of heating rollers 86 is a driving roller that is driven by a motor (not shown), and the other is a driven roller that is driven and rotated by the driving roller. The heating rollers 86 are rotated by driving force of the motor. The heating rollers 86 transport the sheet M formed from the second web W2 towards the cutting portion 90.

The cutting portion 90 cuts the sheet M formed by the sheet forming portion 80 to process the sheet M into a sheet M (hereinafter, referred to as a single sheet M) of a predetermined size. Specifically, the cutting portion 90 includes a first cutting portion 92 that cuts the sheet M in a direction intersecting the transport direction of the sheet M, and a second cutting portion 94 that cuts the sheet M in a direction parallel to the transport direction. The second cutting portion 94 is disposed downstream of the first cutting portion 92 in the transport direction of the sheet M. Subsequently, the sheet M formed by the sheet forming portion 80 is cut into a cutsheet (the single sheet M) of a predetermined size with the first cutting portion 92 and the second cutting portion 94.

The single sheet M cut by the cutting portion 90 is discharged towards a tray 96 and is mounted on the tray 96.

### 1.2 Outline of Powder Collector

FIG. 2 is a schematic view illustrating an outline of the powder collector 3 according to the present exemplary embodiment. In FIG. 2, components of the powder collector 3 are depicted with a solid line, and components other than the components of the powder collector 3 are depicted with a two-dot chain line.

Referring next to FIG. 2, an outline of the powder collector 3 will be described.

As illustrated in FIG. 2, the powder collector 3 includes a collecting portion 241 including filters 240, a box 100 disposed under the collecting portion 241, and a hopper 99 disposed between the collecting portion 241 and the box 100. The collection blower 28 is coupled to an upper portion of the collecting portion 241, and the pipe 23 to which the first web forming portion 45 (see FIG. 1) is coupled to a lower portion of the collecting portion 241. With the operation of the collection blower 28, the collecting portion 241 suctions the unneeded substances that have passed through the mesh belt 46 (see FIG. 1) at the first web forming portion 45 and collects the unneeded substances with the filters 240.

Specifically, the collecting portion 241 includes a first housing 242 that houses the filters 240, and a second housing 243 that is provided above the first housing 242 and that forms a chamber into which the gas from which the unneeded substances have been removed by the filters 240 flow. A partition plate 244 is provided between the first housing 242 and the second housing 243. The plurality of (eight in the present exemplary embodiment) filters 240 are provided on the under surface of partition plate 244.

Each filter 240 has a cylindrical shape with a hollow internal space. The internal space of each filter 240 is in communication with the second housing 243. The unneeded substances included in the gas flowing into the first housing 242 are collected with the filters 240, and the gas from which the unneeded substances have been removed flows into the second housing 243 through the internal spaces of the filters 240. The gas from the second housing 243 and that has passed through the collection blower 28 is discharged to the outside of the sheet manufacturing apparatus 2.

Note that in the example in FIG. 2, the filters 240 each have a cylindrical shape; however, the shapes and the number of filters 240 can be changed as appropriate and, for example, the filters 240 may each have a polygonal cylindrical shape.

In the collecting portion 241, the pipe 23 is coupled to the first housing 242, and the collection blower 28 is coupled to the second housing 243. In other words, the collecting portion 241 is partitioned into a pipe 23 side and a collection blower 28 side with the filters 240.

The collection blower 28 suctions the gas in the second housing 243 and the gas in the first housing 242, and suctions, through the second housing 243, the first housing 242, and the pipe 23, the gas containing the unneeded substances that have passed through the mesh belt 46. In other words, when the collection blower 28 is driven, the unneeded substances dropping below the mesh belt 46 are suctioned into the first housing 242 together with the airflow, and the gas containing unneeded substances in the first housing 242 is suctioned into the second housing 243.

The plurality of filters 240 are provided in the first housing 242 so as to be spaced apart from each other.

Such filters 240 each have a cylindrical shape with a hollow internal space. The internal space inside the cylinder of each filter 240 is in communication with the second housing 243. With the operation of the collection blower 28, the gas that contains unneeded substances and that has flowed into the first housing 242 through the pipe 23 passes through the filters 240, and in this instance, the unneeded substances are collected by the filters 240. The gas, from which the unneeded substances have been removed with the filters 240, passes through the space in the cylinder of each filter 240 and flows into the second housing 243.

The powder collector 3 includes a backwashing mechanism that washes the filters 240 by backwashing the unneeded substances collected in the filters 240. Note that backwashing is an operation of blowing out the unneeded substances adhered to the filters 240 with a backwash airflow in a direction opposite to the direction of the airflow when the unneeded substances are collected with the filters 240.

The powder collector 3 includes compressed gas pipes 246 that introduce the backwash airflow into the filters 240 with compressed gas compressed by a compressor (not shown). Nozzles 248 that discharge the compressed gas into the filters 240 are attached to distal ends of the compressed gas pipes 246. The compressed gas is discharged through the nozzles 248. The above compressed gas generates a backwash airflow from the inside of each filter 240 towards the outside. The backwash airflow is airflow in a direction opposite that of the airflow when the filters 240 collect the unneeded substances and, with such a backwash airflow, the unneeded substances collected with the filters 240 fall off from the surfaces of the filters 240.

Such backwashing recovers the collecting capacity of each filter 240. Furthermore, the unneeded substances that have fallen off from the filters 240 due to backwashing fall in the gravitational direction (the −Z direction), are passed through the hopper 99, and are collected inside a bag 280 installed inside the box 100.

The box 100 is a rectangular parallelepiped hollow box disposed under the hopper 99.

In the description hereinafter, a longitudinal direction of the rectangular parallelepiped box 100 is the X direction, the short direction of the rectangular parallelepiped box 100 is the Y direction, and the height direction of the rectangular parallelepiped box 100 is the Z direction. Furthermore, a distal end side of an arrow that indicates a direction is referred to as a + direction, and a base end side of an arrow that indicates a direction is referred to as a − direction.

A first opening 101 through which the unneeded substances (powder) can pass to the +Z direction side of the box 100 is provided so that the unneeded substances that have fallen off from the filters 240 fall in the box 100 through the hopper 99. The box 100 includes a bottom portion 110 disposed so as to oppose the first opening 101, and side portions 120 that intersect the first opening 101 and the bottom portion 110.

In other words, the box 100 includes the first opening 101 through which the unneeded substances (powder) can pass, the bottom portion 110 disposed so as to oppose the first opening 101, and the side portions 120 that intersect the first opening 101 and the bottom portion 110.

The side portions 120 include a first side portion 121 disposed in the −X direction, a second side portion 122 disposed in the −Y direction, a third side portion 123 disposed in the +X direction, and a fourth side portion 124 disposed in the +Y direction. The first side portion 121, the second side portion 122, the third side portion 123, and the fourth side portion 124 are disposed in order in the counterclockwise direction.

Furthermore, a second opening 102 that is an example of a suction opening is provided in the first side portion 121. The internal space of the box 100 is in communication with the collection blower 28 through the second opening 102, a pipe 105, and the pipe 29, and suction can be performed with the collection blower 28. In other words, the second opening 102 through which suction of the gas in the box 100 can be performed is provided in the box 100.

The switching portion 17 is provided at a portion where the pipe 105 and the pipe 29 merge with each other. The switching portion 17 is, for example, a three-way switching valve. The collection blower 28 is switched between suctioning the gas in the collecting portion 241 and suctioning the gas in the box 100 with the switching portion 17.

When the collection blower 28 is driven, the collection blower 28 suctions the gas in the collecting portion 241 through the pipe 29 and the switching portion 17. Furthermore, when the collection blower 28 is driven, the collection blower 28 suctions the gas in the box 100 through the pipe 29, the switching portion 17, the pipe 105, and the second opening 102.

As described above, the second opening 102 through which suction of the gas in the box 100 can be performed is provided in the first side portion 121 of the box 100. The second opening 102 is provided near the bottom portion 110.

The box 100 is fixed to the hopper 99 with fasteners (draw latches, for example) 107. The fasteners 107 are provided in the first side portion 121 and the third side portion 123. The box 100 and the hopper 99 can be fixed to each other by fastening the fasteners 107.

When the box 100 is fixed to the hopper 99 with the fasteners 107, the inside of the box 100 becomes an airtight space. In order to achieve such airtightness, a joining portion between the box 100 and the hopper 99 is configured to join the box 100 and the hopper 99 in a close state. In the present exemplary embodiment, a sealing member (not shown) formed of a flexible material, such as synthetic resin or rubber, is disposed between the joining portion (a boundary) between the box 100 and the hopper 99.

When the fasteners 107 are released, the fixing between the box 100 and the hopper 99 is released, and the box 100 can be moved outside the powder collector 3.

The bag 280 depicted by a two-dot chain line in the drawing is installed inside the box 100. The bag 280 is installed inside the box 100 so that the bag 280 is in communication with the first opening 101.

The bag 280 is configured of a flexible material such as synthetic resin or rubber, and is flexible. At least a portion of the bag 280 becomes deformed easily. The material of the bag 280 may be any flexible material, and resin such as, for example, polyethylene, polystyrene, polyester, polypropylene, nylon, or vinyl chloride can be used. The bag 280 may be configured of a material in which an inorganic matter, such as calcium, or an organic matter is added thereto, or metal may be deposited thereon. Furthermore, the bag 280 may be configured of a plurality of films adhered to each other.

When the box 100 is fixed to the hopper 99 with the fasteners 107 while the bag 280 is installed inside the box 100, an edge of the bag 280 is disposed outside the box 100 and the space inside the box 100 is partitioned into two spaces, namely, spaces S1 and S2 with the bag 280. In other words, when the box 100 is fixed to the hopper 99 while the bag 280 is installed inside the box 100, the space inside the box 100 is partitioned into the space S1 surrounded by the bottom portion 110, the side portions 120, and the bag 280, and the space S2 on the opposite side of the space S1 with the bag 280 in between. The space S1 is outside the bag 280, and the space S2 is inside the bag 280.

The space S1 disposed outside the bag 280 is in communication with the collection blower 28 through the second opening 102, the pipe 105, the switching portion 17, and the pipe 29.

The operator sets the bag 280 into the box 100 and fixes the box 100 to the hopper 99 with the fasteners 107. Subsequently, the operator drives the collection blower 28 and suctions, with the collection blower 28, the gas in the box 100 (the gas in the space S1) through the pipe 29, the switching portion 17, the pipe 105, and the second opening 102.

By so doing, a pressure of the space S1 disposed outside the bag 280 becomes lower than a pressure of the space S2 disposed inside the bag 280, and owing to the difference between the pressure of the space S1 and the pressure of the space S2, the bag 280 becomes deformed so that a volume of the space S2 disposed inside the bag 280 becomes larger and a volume of the space S1 disposed outside the bag 280 becomes smaller, causing the bag 280 to be in an expanded state inside the box 100.

As described above, when the operator sets the bag 280 into the box 100, the collection blower 28 is driven to cause the bag 280 to be in an expanded state inside the box 100.

When the bag 280 becomes expanded inside the box 100, the operator drives the collection blower 28, and the gas containing the unneeded substances discharged from the suction portion 48 is suctioned by the collection blower 28. Specifically, when the collection blower 28 is driven, the gas containing the unneeded substances discharged from the suction portion 48 is suctioned into the first housing 242 through the pipe 23, passes through the filters 240, is suctioned into the second housing 243, and is discharged outside the collection blower 28 (outside the sheet manufacturing apparatus 2) through the pipe 29 and the collection blower 28.

In so doing, the unneeded substances in the gas containing the unneeded substances are collected by the filters 240 and are removed by the filters 240.

Furthermore, when the unneeded substances are collected by the filters 240 and the collecting capacities of the filters 240 decrease, the operator performs backwashing described above to have the unneeded substances collected in the filters 240 fall off from the surfaces of the filters 240 and to recover the collecting capacities of the filters 240.

The unneeded substances that fell off from the surfaces of the filters 240 fall in the gravitational direction, pass the hopper 99, and are accommodated in the bag 280 that is in an expanded state inside the box 100.

When the bag 280 becomes filled up with the unneeded substances, the operator releases the fixed box 100 and the hopper 99 from each other, moves the box 100 to the outside of the powder collector 3, detaches the bag 280 filled up with the unneeded substances, and replaces the bag 280 with a new bag 280.

Since the bag 280 is in an expanded state inside the box 100, compared with when the bag 280 is in a shrunk state, a large amount of unneeded substances can be accommodated in the bag 280. When a large amount of unneeded substances are accommodated in the bag 280, compared with when a small amount of unneeded substances are stored in the bag 280, the frequency at which the bag 280 filled up with the unneeded substances is replaced with a new bag 280 decreases and the downtime of the sheet manufacturing system 1 caused by replacing the bags 280 becomes shorter and the productivity of the sheet manufacturing system 1 is improved.

However, when the collection blower 28 is driven and the pressure of the space S1 is set lower than the pressure of the space S2, while the bag 280 becomes expanded, force that pushes the bottom portion 110 and the side portions 120 of the box 100 acts on the box 100 due to a pressure difference with the outside. If the mechanical strengths of the bottom portion 110 and the side portions 120 of the box 100 are small, a shortcoming such as the box 100 becoming deformed by the force pressing the bottom portion 110 and the side portions 120 will occur. Accordingly, in the present exemplary embodiment, frames 130 that increase the mechanical strengths of the bottom portion 110 and the side portions 120 of the box 100 are provided to suppress deformation of the box 100 even when force pressing the bottom portion 110 and the side portions 120 act thereon due to the pressure difference with the outside.

As described above, the powder collector 3 according to the present exemplary embodiment includes a plurality of frames 130 that are disposed in at least either one of the bottom portion 110 and the side portions 120 of the box 100. Owing to the plurality of frames 130, the mechanical strengths of the bottom portion 110 and the side portions 120 of the box 100 are increased.

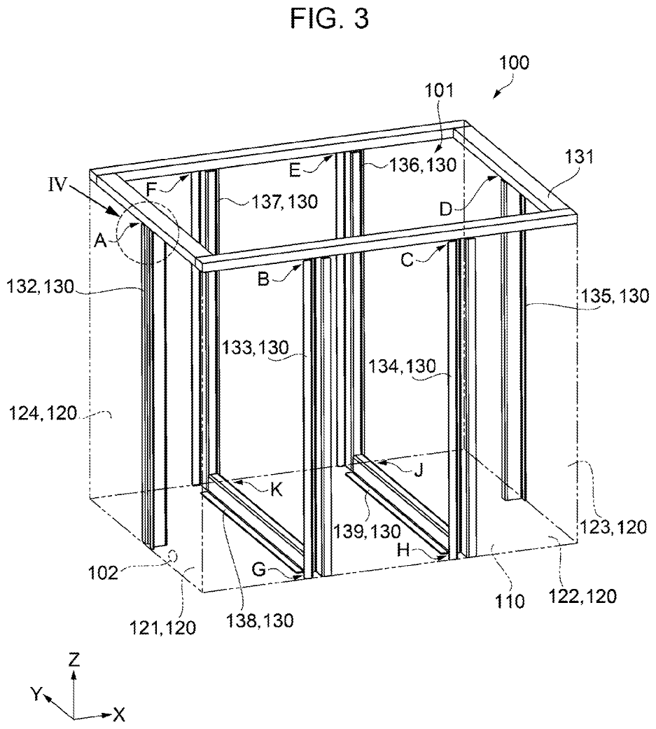

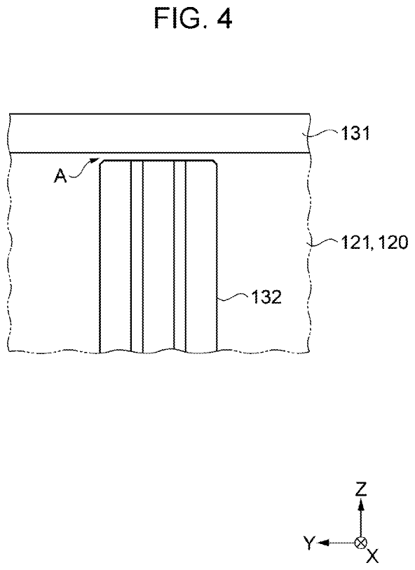

FIG. 3 is a schematic view illustrating a state of the box 100. FIG. 4 is a plan view of an area IV surrounded by a broken line in FIG. 3. In FIG. 3, the outline of the box 100 is depicted by a two-dot chain line, and the outlines of the frames 130 are depicted by solid lines.

As illustrated in FIG. 3, the frames 130 include frames 131 disposed at edges of the side portions 120 in the +Z direction. Other than the frames 131, the frames 130 further include a frame 132, a frame 133, a frame 134, a frame 135, a frame 136, a frame 137, a frame 138, and a frame 139.

Among the plurality of frames 130, the frames 131 form a shape of a picture frame, and an opening defined by inner sides of the frames 131 is the first opening 101. Furthermore, the frames 131 and the hopper 99 are disposed so as to oppose each other with the sealing member in between.

Among the plurality of frames 130, the frames 132, 133, 134, 135, 136, and 137 are members that extend in the Z direction and are provided so as to come in contact with the side portions 120 to increase the mechanical strength of the side portions 120. Specifically, the frame 132 comes in contact with the first side portion 121 to increase the mechanical strength of the first side portion 121. The frames 133 and 134 come in contact with the second side portion 122 to increase the mechanical strength of the second side portion 122. The frame 135 comes in contact with the third side portion 123 to increase the mechanical strength of the third side portion 123. The frames 136 and 137 come in contact with the fourth side portion 124 to increase the mechanical strength of the fourth side portion 124.

Among the plurality of frames 130, the frames 138 and 139 are members that extend in the Y direction and are provided so as to come in contact with the bottom portion 110 to increase the mechanical strength of the bottom portion 110.

As described above, the powder collector 3 according to the present exemplary embodiment includes the plurality of frames 130 (the frames 131, 132, 133, 134, 135, 136, 137, 138, and 139) that are disposed in at least either one of the bottom portion 110 and the side portions 120.

As illustrated in FIG. 4, a gap is provided between the frame 131 and the frame 132 so that the gas is allowed to flow therethrough. The gap between the frame 131 and the frame 132 is a flow portion A through which the gas is allowed to flow. The gap between the frame 131 and the frame 132, in other words, the dimension of the flow portion A in the Z direction is substantially from 0.1 mm to 0.35 mm.

As described above, the flow portion A through which the gas is allowed to flow is a gap formed between a primary frame (the frame 131) among the plurality of frames 131, 132, 133, 134, 135, 136, 137, 138, and 139, and a secondary frame (the frame 132) among the plurality of frames 131, 132, 133, 134, 135, 136, 137, 138, and 139.

Referring back to FIG. 3, a gap is formed between the frame 131 and the frame 133 so that the gas is allowed to flow therethrough. The gap between the frame 131 and the frame 133 is a flow portion B through which the gas is allowed to flow.

Furthermore, a gap is provided between the frame 131 and the frame 134 so that the gas is allowed to flow therethrough. The gap between the frame 131 and the frame 134 is a flow portion C through which the gas is allowed to flow.

Furthermore, a gap is provided between the frame 131 and the frame 135 so that the gas is allowed to flow therethrough. The gap between the frame 131 and the frame 135 is a flow portion D through which the gas is allowed to flow.

Furthermore, a gap is provided between the frame 131 and the frame 136 so that the gas is allowed to flow therethrough. The gap between the frame 131 and the frame 136 is a flow portion E through which the gas is allowed to flow.

Furthermore, a gap is provided between the frame 131 and the frame 137 so that the gas is allowed to flow therethrough. The gap between the frame 131 and the frame 137 is a flow portion F through which the gas is allowed to flow.

Furthermore, a gap is provided between the frame 133 and the frame 138 so that the gas is allowed to flow therethrough. The gap between the frame 133 and the frame 138 is a flow portion G through which the gas is allowed to flow.

Furthermore, a gap is provided between the frame 134 and the frame 139 so that the gas is allowed to flow therethrough. The gap between the frame 134 and the frame 139 is a flow portion H through which the gas is allowed to flow.

Furthermore, a gap is provided between the frame 136 and the frame 139 so that the gas is allowed to flow therethrough. The gap between the frame 136 and the frame 139 is a flow portion J through which the gas is allowed to flow.

Furthermore, a gap is provided between the frame 137 and the frame 138 so that the gas is allowed to flow therethrough. The gap between the frame 137 and the frame 138 is a flow portion K through which the gas is allowed to flow.

As described above, the powder collector 3 according to the present exemplary embodiment includes the flow portion A formed between the primary frame (the frame 131) and the secondary frame (the frame 132), the flow portion B formed between the primary frame (the frame 131) and the secondary frame (the frame 133), the flow portion C formed between the primary frame (the frame 131) and the secondary frame (the frame 134), the flow portion D formed between the primary frame (the frame 131) and the secondary frame (the frame 135), the flow portion E formed between the primary frame (the frame 131) and the secondary frame (the frame 136), the flow portion F formed between the primary frame (the frame 131) and the secondary frame (the frame 137), the flow portion G formed between the primary frame (the frame 133) and the secondary frame (the frame 138), the flow portion H formed between the primary frame (the frame 134) and the secondary frame (the frame 139), the flow portion J formed between the primary frame (the frame 136) and the secondary frame (the frame 139), and the flow portion K formed between the primary frame (the frame 137) and the secondary frame (the frame 138).

The powder collector 3 according to the present exemplary embodiment includes ten flow portions A, B, C, D, E, F, G, H, J, and K. The ten flow portions A, B, C, D, E, F, G, H, J, and K are disposed in the space S1 (see FIG. 2) surrounded by the bottom portion 110, the side portions 120, and the bag 280.

In the powder collector 3 according to the present exemplary embodiment, the collection blower 28 is driven, the gas is suctioned from the space S1, the pressure of the space S1 is set lower than the pressure of space S2, and the bag 280 is set to be in an expanded state inside the box 100. Furthermore, when the collection blower 28 is driven and the pressure of the space S1 is set lower than the pressure of the space S2, the box 100 may become deformed due to the pressure difference with the outside; accordingly, the frames 130 are provided in the bottom portion 110 and the side portions 120 of the box 100 to increase the mechanical strength of the bottom portion 110 and the side portions 120.

However, when the frames 130 are provided in the bottom portion 110 and the side portions 120 of the box 100, the frames 130 become obstacles that inhibit the flow of the gas, and discharging of the gas from the entire space S1 surrounded by the bottom portion 110, the side portions 120, and the bag 280 may become difficult. If it is difficult to discharge the gas from the entire space S1, unevenness in the pressure in the space S1 will occur.

Then, it will be difficult for the bag 280 to become uniformly expanded throughout the entire box 100, and compared with when the bag 280 is expanded uniformly throughout the entire box 100, the volume of the bag 280 that can accommodate the unneeded substances becomes small, the amount of the unneeded substances that can be accommodated in the bag 280 becomes small, and the bag 280 tends to become filled up with the unneeded substances in a short time. As a result, since the bag 280 is replaced more frequently, the downtime of the sheet manufacturing system 1 caused by replacing the bag 280 becomes long, and the productivity of the sheet manufacturing system 1 is reduced.

In the present exemplary embodiment, each of the flow portions A, B, C, D, E, F, G, H, J, and K are provided between a corresponding primary frame 130 among the plurality of frames 130 and a corresponding secondary frame 130 among the plurality of frames 130.

With the above, discharging of the gas from the entire space S1 surrounded by the bottom portion 110, the side portions 120, and the bag 280 is facilitated, and a uniform expansion of the bag 280 throughout the entire box 100 is facilitated; accordingly, compared with when the bag 280 does not expand uniformly throughout the entire box 100, the volume of the bag 280 in which the unneeded substances can be accommodated is large, and the bag 280 is less likely to become filled up with the unneeded substances. As a result, excellent effects such as the bag 280 being replaced at a lower frequency, the downtime of the sheet manufacturing system 1 being shorter, and the productivity of the sheet manufacturing system 1 being improved can be obtained.

### 2. Second Exemplary Embodiment

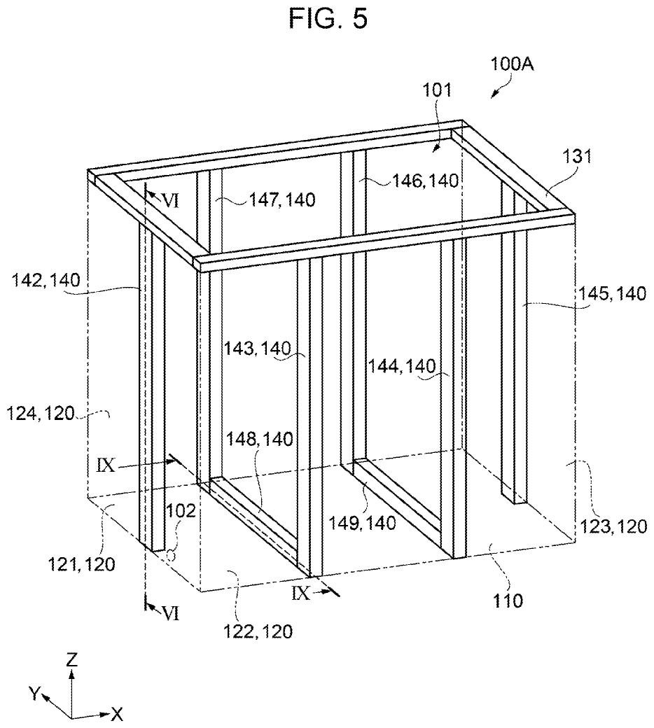

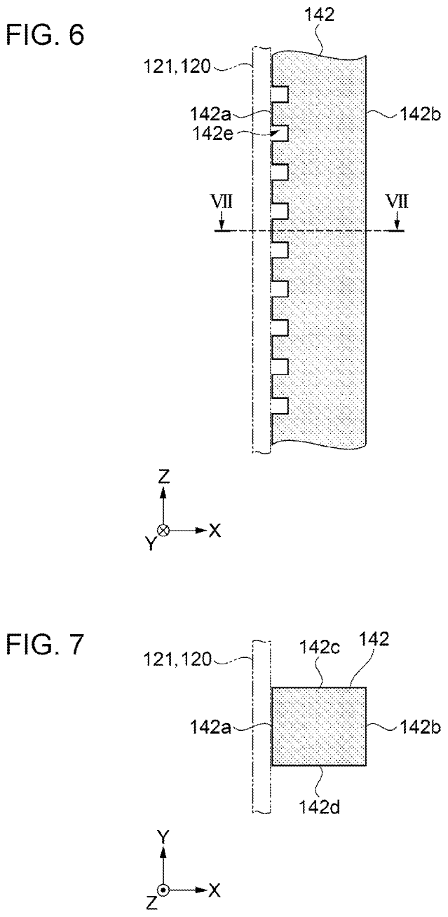

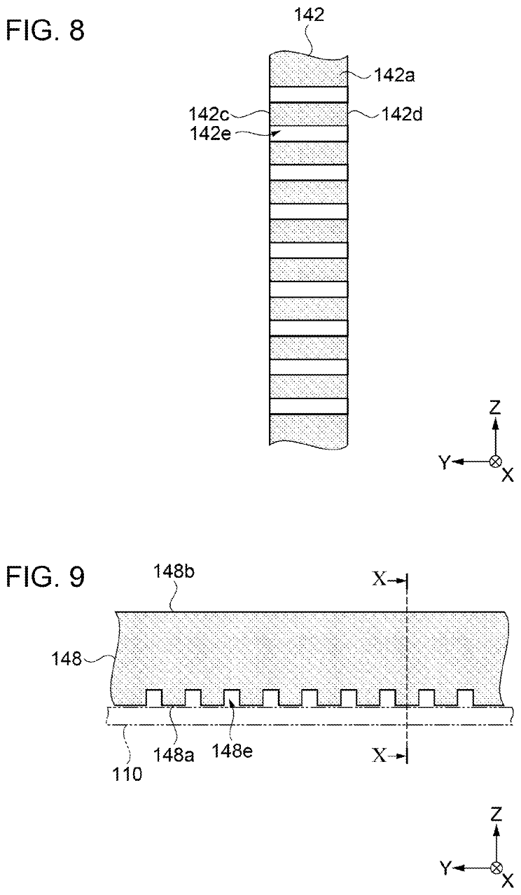

FIG. 5 is a drawing corresponding to FIG. 3 and is a schematic view illustrating a state of the frames 131 and frames 140 of a box 100A included in a powder collector according to a second exemplary embodiment. FIG. 6 is a cross-sectional view of a frame 142 taken along line VI-VI in FIG. 5. FIG. 7 is another cross-sectional view of the frame 142 taken along line VII-VII in FIG. 6. FIG. 8 is a plan view of a fourth surface 142a of the frame 142. In other words, FIG. 6 is a cross-sectional view of the frame 142 cut along a XZ plane, and FIG. 7 is another cross-sectional view of the frame 142 cut along a XY plane.

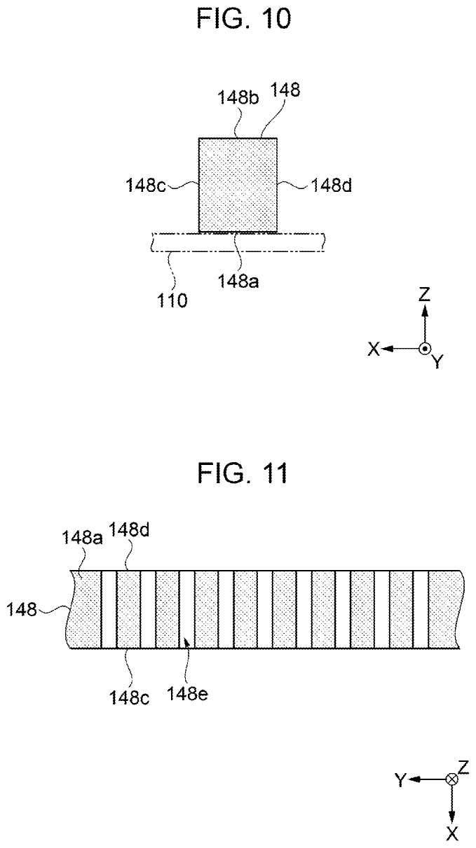

FIG. 9 is a cross-sectional view of a frame 148 taken along line IX-IX in FIG. 5. FIG. 10 is another cross-sectional view of the frame 148 taken along line X-X in FIG. 9. FIG. 11 is a plan view of a first surface 148a of the frame 148. In other words, FIG. 9 is a cross-sectional view of the frame 148 cut along a YZ plane, and FIG. 10 is another cross-sectional view of the frame 148 cut along an XZ plane.

In FIG. 5, the outline of the box 100A is depicted by a two-dot chain line, and the outlines of the frames 140 are depicted by solid lines. In FIGS. 6 and 7, the first side portion 121 is depicted by a two-dot chain line, and hatching is provided in the frame 142. In FIGS. 9 and 10, the bottom portion 110 is depicted by a two-dot chain line, and hatching is provided in the frame 148.

The frames 131 of the present exemplary embodiment is the same as the frames 131 of the first exemplary embodiment. The frames 140 of the present exemplary embodiment is different from the frames 130 of the first exemplary embodiment. Such is the main difference between the present exemplary embodiment and the first exemplary embodiment.

Hereinafter, the difference from the first exemplary embodiment will be described mainly and description overlapping the first exemplary embodiment will be omitted.

The frames 140 include the frame 142, a frame 143, a frame 144, a frame 145, a frame 146, a frame 147, the frame 148, and a frame 149.

Among the plurality of frames 140, the frames 148 and 149 are members that extend in the Y direction and are in contact with the bottom portion 110 to increase the mechanical strength of the bottom portion 110. Note that the frames 148 and 149 that are in contact with the bottom portion 110 are each an example of a tertiary frame in the present application.

Among the plurality of frames 140, the frames 142, 143, 144, 145, 146, and 147 are members that extend in the Z direction and are in contact with the side portions 120 to increase the mechanical strength of the side portions 120. Specifically, the frame 142 comes in contact with the first side portion 121 to increase the mechanical strength of the first side portion 121. The frames 143 and 144 come in contact with the second side portion 122 to increase the mechanical strength of the second side portion 122. The frame 145 comes in contact with the third side portion 123 to increase the mechanical strength of the third side portion 123. The frames 146 and 147 come in contact with the fourth side portion 124 to increase the mechanical strength of the fourth side portion 124.

Note that the frames 142, 143, 144, 145, 146, and 147 that are in contact with the side portions 120 are each and example of a quaternary frame in the present application.

As illustrated in FIG. 7, the frame 142 in contact with the first side portion 121 includes the fourth surface 142a in contact with the first side portion 121, a fifth surface 142b on a side opposite the fourth surface 142a, and sixth surfaces 142c and 142d that intersect the fourth surface 142a and the fifth surface 142b. The sixth surface 142c is disposed in the +Y direction, and the sixth surface 142d is disposed in the −Y direction.

While not shown, the frame 143 in contact with the second side portion 122 includes the fourth surface 143a in contact with the second side portion 122, a fifth surface 143b on a side opposite the fourth surface 143a, and sixth surfaces 143c and 143d that intersect the fourth surface 143a and the fifth surface 143b.

The frame 144 in contact with the second side portion 122 includes a fourth surface 144a that is in contact with the second side portion 122, a fifth surface 144b on a side opposite the fourth surface 144a, and sixth surfaces 144c and 144d that intersect the fourth surface 144a and the fifth surface 144b.

The frame 145 in contact with the third side portion 123 includes a fourth surface 145a that is in contact with the third side portion 123, a fifth surface 145b on a side opposite the fourth surface 145a, and sixth surfaces 145c and 145d that intersect the fourth surface 145a and the fifth surface 145b.

The frame 146 in contact with the fourth side portion 124 includes a fourth surface 146a that is in contact with the fourth side portion 124, a fifth surface 146b on a side opposite the fourth surface 146a, and sixth surfaces 146c and 146d that intersect the fourth surface 146a and the fifth surface 146b.

The frame 147 in contact with the fourth side portion 124 includes a fourth surface 147a that is in contact with the fourth side portion 124, a fifth surface 147b on a side opposite the fourth surface 147a, and sixth surfaces 147c and 147d that intersect the fourth surface 147a and the fifth surface 147b.

As illustrated in FIGS. 6 and 8, in the frame 142, grooves 142e are formed in the fourth surface 142a that is in contact with the first side portion 121.

Note that in FIG. 8, portions in the fourth surface 142a of the frame 142 where the grooves 142e are not formed is hatched, and portions where the grooves 142e are formed are not hatched. In other words, the white solid areas in FIG. 8 are the grooves 142e.

The frame 142 extends in the Z direction, and the grooves 142e each extend in a direction (the Y direction) that intersects the direction (the Z direction) in which the frame 142 extends. A plurality of grooves 142e are arranged in the fourth surface 142a of the frame 142 in the Z direction. Each groove 142e is, in a state in which the fourth surface 142a of the frame 142 is in contact with the first side portion 121, a gap formed between the fourth surface 142a of the frame 142 and the first side portion 121. The gas is allowed to flow through the gaps. As described above, the plurality of grooves 142e through which the gas is allowed to flow are formed in the fourth surface 142a of the frame 142. Note that the groove 142e is, in the present application, an example of a flow portion through which the gas is allowed to flow.

Similarly, grooves 143e (not shown) are formed in the fourth surface 143a of the frame 143. Each of the grooves 143e extends in a direction (the X direction) that intersects the direction (the Z direction) in which the frame 143 extends and is a gap formed between the fourth surface 143a of the frame 143 and the second side portion 122. The gas is allowed to flow through each gap.

Similarly, grooves 144e (not shown) are formed in the fourth surface 144a of the frame 144. Each of the grooves 144e extends in a direction (the X direction) that intersects the direction (the Z direction) in which the frame 144 extends and is a gap formed between the fourth surface 144a of the frame 144 and the second side portion 122. The gas is allowed to flow through each gap.

Similarly, grooves 145e (not shown) are formed in the fourth surface 145a of the frame 145. Each of the grooves 145e extends in a direction (the Y direction) that intersects the direction (the Z direction) in which the frame 145 extends and is a gap formed between the fourth surface 145a of the frame 145 and the third side portion 123. The gas is allowed to flow through each gap.

Similarly, grooves 146e (not shown) are formed in the fourth surface 146a of the frame 146. Each of the grooves 146e extends in a direction (the X direction) that intersects the direction (the Z direction) in which the frame 146 extends and is a gap formed between the fourth surface 146a of the frame 146 and the fourth side portion 124. The gas is allowed to flow through each gap.

Similarly, grooves 147e (not shown) are formed in the fourth surface 147a of the frame 147. Each of the grooves 147e extends in a direction (the X direction) that intersects the direction (the Z direction) in which the frame 147 extends and is a gap formed between the fourth surface 147a of the frame 147 and the fourth side portion 124. The gas is allowed to flow through each gap.

Note that the grooves 143e, 144e, 145e, 146e, and 147e are, in the present application, each an example of a flow portion through which the gas is allowed to flow.

As described above, in the present exemplary embodiment, grooves 142e, 143e, 144e, 145e, 146e, and 147e, through which the gas is allowed to flow, are formed in the fourth surfaces 142a, 143a, 144a, 145a, 146a, and 147a of the frames 142, 143, 144, 145, 146, and 147.

Note that the grooves through which the gas is allowed to flow are not limited to the fourth surfaces 142a, 143a, 144a, 145a, 146a, and 147a of the frames 142, 143, 144, 145, 146, and 147 and may be formed in the fifth surfaces 142b, 143b, 144b, 145b, 146b, and 147b of the frames 142, 143, 144, 145, 146, and 147, or may be formed in the sixth surfaces 142c, 142d, 143c, 143d, 144c, 144d, 145c, 145d, 146c, 146d, 147c, and 147d of the frames 142, 143, 144, 145, 146, and 147.

In other words, it is only sufficient that the grooves (the flow portions) through which the gas is allowed to flow are formed at least in either the fourth surfaces 142a, 143a, 144a, 145a, 146a, and 147a of the frames 142, 143, 144, 145, 146, and 147; the fifth surfaces 142b, 143b, 144b, 145b, 146b, and 147b of the frames 142, 143, 144, 145, 146, and 147; and the sixth surfaces 142c, 142d, 143c, 143d, 144c, 144d, 145c, 145d, 146c, 146d, 147c, and 147d of the frames 142, 143, 144, 145, 146, and 147.

As illustrated in FIG. 10, the frame 148 in contact with the bottom portion 110 includes the first surface 148a in contact with the bottom portion 110, a second surface 148b on a side opposite the first surface 148a, and third surfaces 148c and 148d that intersect the first surface 148a and the second surface 148b. The third surface 148c is disposed in the +X direction, and the third surface 148d is disposed in the −X direction.

While not shown in the drawings, the frame 149 in contact with the bottom portion 110 includes a first surface 149a in contact with the bottom portion 110, a second surface 149b on a side opposite the first surface 149a, and third surface 149c and 149d that intersect the first surface 149a and the second surface 149b. The third surface 149c is disposed in the +X direction, and the third surface 149d is disposed in the −X direction.

As illustrated in FIGS. 9 and 11, grooves 148e are formed in the first surface 148a of the frame 148, which is in contact with the bottom portion 110.

Note that in FIG. 11, portions in the first surface 148a of the frame 148 where the grooves 148e are not formed is hatched, and portions where the grooves 148e are formed are not hatched. In other words, the white solid areas in FIG. 11 are the grooves 148e.

The frame 148 extends in the Y direction, and the grooves 148e each extend in a direction (the X direction) that intersects the direction (the Y direction) in which the frame 148 extends. The plurality of grooves 148e each extending in the direction (the X direction) that intersects the direction (the Y direction) in which the frame 148 extends are arranged in the Y direction in the first surface 148a of the frame 148. Each groove 148e is, in a state in which the first surface 148a of the frame 148 is in contact with the bottom portion 110, a gap formed between the first surface 148a of the frame 148 and the bottom portion 110. The gas is allowed to flow through the gaps. As described above, the plurality of grooves 148e through which the gas is allowed to flow are formed in the first surface 148a of the frame 148.

Similarly, grooves 149e (not shown) are formed in the first surface 149a of the frame 149. Each of the grooves 149e extends in a direction (the X direction) that intersects the direction (the Y direction) in which the frame 149 extends and is a gap formed between the first surface 149a of the frame 149 and the bottom portion 110. The gas is allowed to flow through each gap.

Note that the grooves 148e and 149e are, in the present application, each an example of a flow portion through which the gas is allowed to flow.

As described above, in the present exemplary embodiment, the grooves 148e and 149e, through which the gas is allowed to flow, are formed in the first surfaces 148a and 149a of the frames 148 and 149.

Note that the grooves through which the gas is allowed to flow are not limited to the first surfaces 148a and 149a of the frames 148 and 149 and may be formed in the second surfaces 148b and 149b of the frames 148 and 149, or may be formed in the third surfaces 148c, 148d, 149c, and 149d of the frames 148 and 149.

In other words, it is only sufficient that the grooves (the flow portions) through which the gas is allowed to flow are formed at least in either the first surfaces 148a and 149a of the frames 148 and 149; the second surfaces 148b and 149b of the frames 148 and 149; and the third surfaces 148c, 148d, 149c, and 149d of the frames 148 and 149.

In the present exemplary embodiment, the grooves 148e and 149e through which the gas is allowed to flow are formed in the first surfaces 148a and 149a of the frames 148 and 149, and the grooves 142e, 143e, 144e, 145e, 146e, and 147e through which the gas is allowed to flow are formed in the fourth surfaces 142a, 143a, 144a, 145a, 146a, and 147a of the frames 142, 143, 144, 145, 146, and 147.

With the above, discharging of the gas from the entire space S1 surrounded by the bottom portion 110, the side portions 120, and the bag 280 is facilitated, and a uniform expansion of the bag 280 throughout the entire box 100 is facilitated; accordingly, compared with when the bag 280 does not expand uniformly throughout the entire box 100, the volume of the bag 280 in which the unneeded substances can be accommodated is large, and the bag 280 is less likely to become filled up with the unneeded substances. As a result, excellent effects such as the bag 280 being replaced at a lower frequency, the downtime of the sheet manufacturing system 1 being shorter, and the productivity of the sheet manufacturing system 1 being improved can be obtained.

### 3. Third Exemplary Embodiment

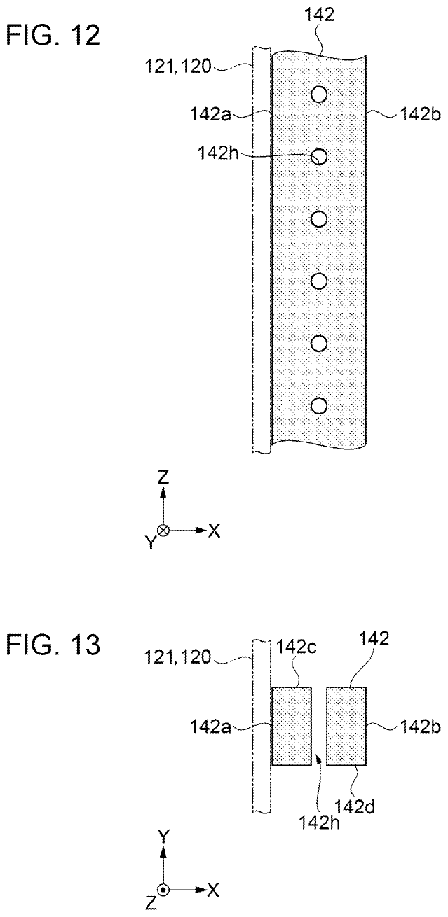

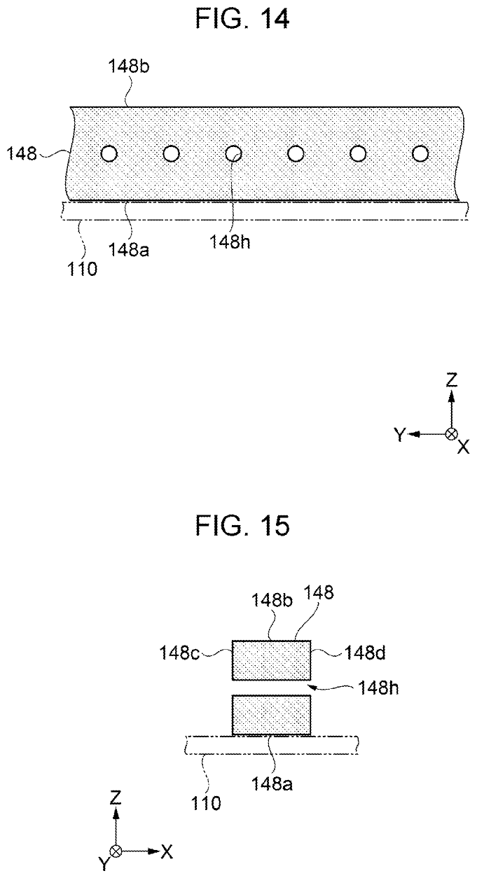

FIG. 12 is a drawing corresponding to FIG. 6 and is a cross-sectional view of a frame 142 included in a powder collector according to a third exemplary embodiment. FIG. 13 is a drawing corresponding to FIG. 7 and is another cross-sectional view of the frame 142. FIG. 14 is a drawing corresponding to FIG. 9 and is a cross-sectional view of a frame 148. FIG. 15 is a drawing corresponding to FIG. 10 and is another cross-sectional view of the frame 148.

In other words, FIG. 12 is a cross-sectional view of the frame 142 cut along an XZ plane, and FIG. 13 is another cross-sectional view of the frame 142 cut along a XY plane. FIG. 14 is a cross-sectional view of the frame 148 cut along an YZ plane, and FIG. 15 is another cross-sectional view of the frame 148 cut along an XZ plane.

The configuration of the flow portions through which the gas is allowed to flow is different between the present exemplary embodiment and the second exemplary embodiment, and such is the main difference between the present exemplary embodiment and the second exemplary embodiment.

Hereinafter, the difference from the second exemplary embodiment will be described mainly and description overlapping the second exemplary embodiment will be omitted.

As illustrated in FIG. 13, the frame 142 in contact with the first side portion 121 includes the fourth surface 142a in contact with the first side portion 121, the fifth surface 142b on a side opposite the fourth surface 142a, and the sixth surfaces 142c and 142d that intersect the fourth surface 142a and the fifth surface 142b.

As illustrated in FIGS. 12 and 13, holes 142h that penetrate through the frame 142 is formed in the frame 142. Each hole 142h that penetrates through the frame 142 is provided so as to penetrate from a center of the sixth surface 142c of the frame 142 to a center of the sixth surface 142d of the frame 142, and is provided so as to extend in the Y direction. The plurality of holes 142h that penetrate the frame 142 are provided in the Z direction and gas is allowed to flow therethrough. By providing the holes 142h that penetrate through the frame 142, the gas is allowed to flow through the frame 142.

Note that the hole 142h is, in the present application, an example of a flow portion through which the gas is allowed to flow.

Similarly, holes 143h (not shown) that penetrate through the frame 143 are formed in the frame 143. Holes 144h (not shown) that penetrate through the frame 144 are formed in the frame 144. Holes 145h (not shown) that penetrate through the frame 145 are formed in the frame 145. Holes 146h (not shown) that penetrate through the frame 146 are formed in the frame 146. Holes 147h (not shown) that penetrate through the frame 147 are formed in the frame 147.

By providing the holes 143h, 144h, 145h, 146h, and 147h that penetrate through the frames 143, 144, 145, 146, and 147, the gas is allowed to flow through the frames 143, 144, 145, 146, and 147.

Note that the holes 143h, 144h, 145h, 146h, and 147h are each an example of the flow portion according to the present application.

As illustrated in FIG. 15, the frame 148 in contact with the bottom portion 110 includes the first surface 148a in contact with the bottom portion 110, the second surface 148b on a side opposite the first surface 148a, and the third surfaces 148c and 148d that intersect the first surface 148a and the second surface 148b.

As illustrated in FIGS. 14 and 15, holes 148h that penetrate through the frame 148 is formed in the frame 148. Each hole 148h that penetrates through the frame 148 is provided so as to penetrate from a center of the third surface 148c of the frame 148 to a center of the third surface 148d of the frame 148, and is provided so as to extend in the X direction. The plurality of holes 148h that penetrate the frame 148 are provided in the Y direction and the gas is allowed to flow therethrough. By providing the holes 148h that penetrate through the frame 148, the gas is allowed to flow through the frame 148.

Similarly, holes 149h (not shown) that penetrate through the frame 149 are formed in the frame 149. By providing the holes 149h that penetrate through the frame 149, the gas is allowed to flow through the frame 149.

Note that the holes 148h and 149h are each, in the present application, an example of a flow portion through which the gas is allowed to flow.

As described above, in the present exemplary embodiment, the holes 142h, 143h, 144h, 145h, 146h, 147h, 148h, and 149h that penetrate through the frames 142, 143, 144, 145, 146, 147, 148, and 149 are the flow portions that allow the gas to flow therethrough. In the second exemplary embodiment, the grooves 142e, 143e, 144e, 145e, 146e, 147e, 148e, and 149e that are provided in the surfaces of the frames 142, 143, 144, 145, 146, 147, 148, and 149 are the flow portions that allow the gas to flow therethrough.

Such is the main difference between the present exemplary embodiment and the second exemplary embodiment.

In the present exemplary embodiment, by providing the holes 142h, 143h, 144h, 145h, 146h, 147h, 148h, and 149h that penetrate through the frames 142, 143, 144, 145, 146, 147, 148, and 149, the gas is allowed to flow through the frames 142, 143, 144, 145, 146, 147, 148, and 149.

With the above, discharging of the gas from the entire space S1 surrounded by the bottom portion 110, the side portions 120, and the bag 280 is facilitated, and a uniform expansion of the bag 280 throughout the entire box 100 is facilitated; accordingly, compared with when the bag 280 does not expand uniformly throughout the entire box 100, the volume of the bag 280 in which the unneeded substances can be accommodated is large, and the bag 280 is less likely to become filled up with the unneeded substances. As a result, excellent effects such as the bag 280 being replaced at a lower frequency, the downtime of the sheet manufacturing system 1 being shorter, and the productivity of the sheet manufacturing system 1 being improved can be obtained.

### 4. Fourth Exemplary Embodiment

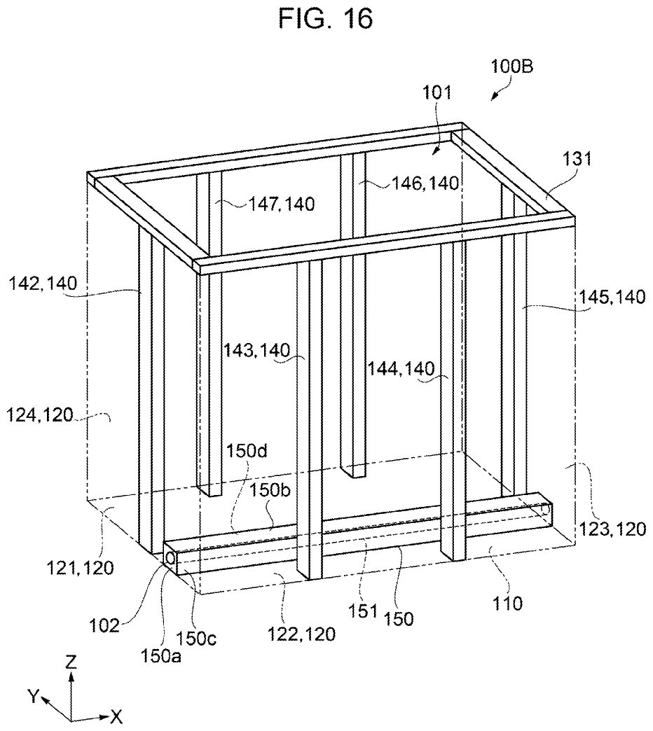

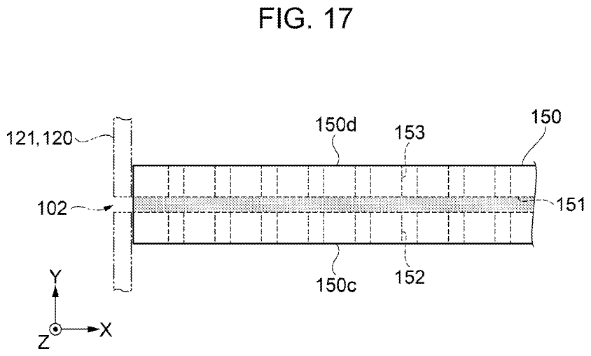

FIG. 16 is a drawing corresponding to FIG. 5 and is a schematic view illustrating a state of frames of a box 100B included in a powder collector according to a fourth exemplary embodiment. FIG. 17 is a plan view of a frame 150 viewed in the Z direction.

As illustrated in FIG. 16, the box 100B included in a powder collector according to the present exemplary embodiment includes the frame 142, the frame 143, the frame 144, the frame 145, the frame 146, the frame 147, and the frame 150. On the other hand, as illustrated in FIG. 5, the box 100A included in the powder collector according to the second exemplary embodiment includes the frame 142, the frame 143, the frame 144, the frame 145, the frame 146, the frame 147, the frame 148, and the frame 149.

The frame 142, the frame 143, the frame 144, the frame 145, the frame 146, and the frame 147 in the present exemplary embodiment and those in the second exemplary embodiment are the same. In the present exemplary embodiment, the frame 148 and the frame 149 of the second exemplary embodiment are omitted and the frame 150 is newly provided instead. Such is the main difference between the present exemplary embodiment and the second exemplary embodiment.

Hereinafter, the difference from the second exemplary embodiment will be described mainly and description overlapping the second exemplary embodiment will be omitted.

As illustrated in FIG. 16, the frame 150 is a member that extends in the X direction and is in contact with the bottom portion 110 at a portion between the first side portion 121 and the third side portion 123 to increase the mechanical strength of the bottom portion 110. The frame 150 is disposed so as to cover the second opening 102 provided in the first side portion 121.

The frame 150 includes a first surface 150a in contact with the bottom portion 110, a second surface 150b on a side opposite the first surface 150a, and third surfaces 150c and 150d that intersect the first surface 150a and the second surface 150b. The third surface 150c is disposed in the −Y direction, and the third surface 150d is disposed in the +Y direction.

A hole 151 that is an example of a first hole is formed in the frame 150. The hole 151 extends in a direction (the X direction) in which the frame 150 extends. The hole 151 is a hole that penetrates the frame 150 in the X direction and through a center of the frame 150. A first end (an end in the −X direction) of the hole 151 is in contact with the first side portion 121 and is in communication with the second opening 102. A second end (an end in the +X direction) of the hole 151 is in contact with the third side portion 123 and is closed by the third side portion 123.

Note that in FIG. 16, illustration of holes 152 and 153 described below are omitted.

As illustrated in FIG. 17, in addition to the hole 151 described above, the holes 152 that are each an example of a second hole, and the holes 153 that are each an example of the second hole are formed in the frame 150. Note that in FIG. 17, hatching is provided in the hole 151 that is an example of the first hole.

Each of the holes 152 and 153 extends in a direction (the Y direction) that intersects the direction in which the frame 150 extends, is in communication with the hole 151, and, further, is in communication with the second opening 102 through the hole 151.

The holes 152 are disposed between the hole 151 and the third surface 150c and are formed to penetrate through the third surface 150c. The plurality of holes 152 are formed in the X direction. The holes 153 are disposed between the hole 151 and the third surface 150d and are formed to penetrate through the third surface 150d. The plurality of holes 153 are formed in the X direction.

The gas in the space S1 outside the third surfaces 150c and 150d (the space S1 (see FIG. 2) that is outside the bag 280) can be suctioned through the holes 152 and 153, the hole 151, and the second opening 102.

Note that the holes 151, 152, and 153 are each an example of the flow portion according to the present application.

As described above, the present exemplary embodiment has a configuration in which the second opening 102 is covered by the frame 150, and the flow portions through which the gas is allowed to flow are the holes 151, 152, and 153 provided in the frame 150.

Furthermore, the present exemplary embodiment has a configuration in which the flow portions through which the gas is allowed to flow include the hole 151 that is in communication with the second opening 102 and the extends in the direction (the X direction) in which the frame 150 extends, and the holes 152 and 153 that are in communication with the hole 151 and that each extend in the direction (the Y direction) that intersects the direction in which the frame 150 extends, and in which the gas inside the box 100 can be suctioned through the hole 151, and the holes 152 and 153.

Furthermore, the present exemplary embodiment has a configuration in which the frame 150 is in contact with the bottom portion 110, and in which the holes 152 and 153 are formed so as to penetrate through the third surfaces 150c and 150d that intersect the first surface 150a, which is in contact with the bottom portion 110, and the second surface 150b, which is on the side opposite the first surface 150a, of the frame 150.

In the present exemplary embodiment, the gas inside the box 100B (the gas in the space S1) can be suctioned through the plurality of holes 152 that penetrate through the third surface 150c of the frame 150, and through the plurality of holes 153 that penetrate through the third surface 150d of the frame 150. In other words, in the present exemplary embodiment, since the gas inside the box 100B can be suctioned through the plurality of suction openings (the holes 152 and 153), compared with when suction can be performed through a single suction opening (the second opening 102), a trouble such as, for example, the suction opening becoming blocked by the bag 280 does not easily occur, and the gas inside the box 100B can be suctioned in a stable manner.

In a state in which the bag 280 is installed inside the box 100, the second surface 150b of the frame 150 is disposed so as to oppose the bag 280 and is disposed closer to the bag 280 than the third surfaces 150c and 150d of the frame 150. When the bag 280 becomes expanded inside the box 100, the bag 280 easily comes in contact with the second surface 150b and does not easily come in contact with the third surfaces 150c and 150d that intersect the second surface 150b.

If the suction openings (the holes 152 and 153) are formed in the second surface 150b, the bag 280 will come in contact with the second surface 150b and the bag 280 will close the suction openings (the holes 152 and 153) formed in the second surface 150b, and it will be difficult for the gas inside the box 100B to be suctioned.

When the suction openings (the holes 152 and 153) are formed in the third surfaces 150c and 150d that intersect the second surface 150b, the bag 280 does not easily come in contact with the third surfaces 150c and 150d; accordingly, the suction openings (the holes 152 and 153) formed in the third surfaces 150c and 150d are not easily closed by the bag 280, and the gas inside the box 100B can be suctioned in a stable manner.

When the gas inside the box 100B can be suctioned in a stable manner, the bag 280 tends to become expanded throughout the entire box 100B in a stable manner; accordingly, compared with when the bag 280 is not expanded throughout the entire box 100B in a stable manner, the volume of the bag 280 that can accommodate the unneeded substances is large and the bag 280 does not easily become filled up with the unneeded substances. As a result, excellent effects such as the bag 280 being replaced at a lower frequency, the downtime of the sheet manufacturing system 1 being shorter, and the productivity of the sheet manufacturing system 1 being improved can be obtained.

### 5. Fifth Exemplary Embodiment

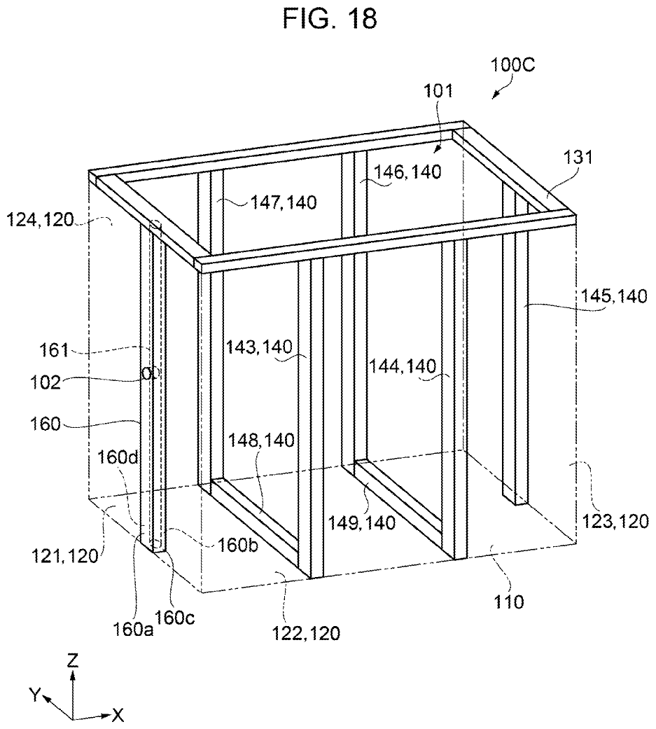

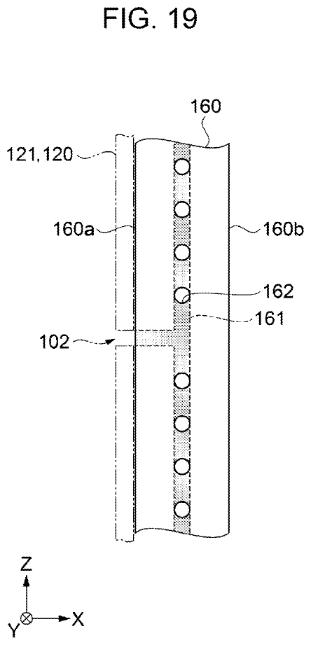

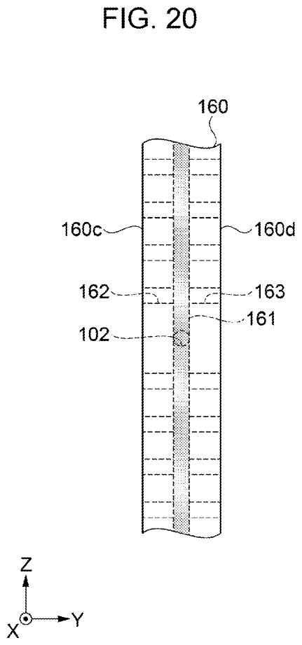

FIG. 18 is a drawing corresponding to FIG. 5 and is a schematic view illustrating a state of frames of a box 100C included in a powder collector according to a fifth exemplary embodiment. FIG. 19 is a plan view of a frame 160 viewed in the Y direction. FIG. 20 is a plan view of the frame 160 viewed in the X direction.

As illustrated in FIG. 18, the box 100C included in the powder collector according to the present exemplary embodiment includes the frame 143, the frame 144, the frame 145, the frame 146, the frame 147, the frame 148, and the frame 149, and the frame 160. On the other hand, as illustrated in FIG. 5, the box 100A included in the powder collector according to the second exemplary embodiment includes the frame 142, the frame 143, the frame 144, the frame 145, the frame 146, the frame 147, the frame 148, and the frame 149.

The frame 143, the frame 144, the frame 145, the frame 146, the frame 147, the frame 148, and the frame 149 in the present exemplary embodiment and those in the second exemplary embodiment are the same. In the present exemplary embodiment, the frame 142 of the second exemplary embodiment is omitted and the frame 160 is newly provided instead. Furthermore, a position of the second opening 102 in the present exemplary embodiment is different from that in the second exemplary embodiment. Such are the main differences between the present exemplary embodiment and the second exemplary embodiment.

Hereinafter, the difference from the second exemplary embodiment will be described mainly and description overlapping the second exemplary embodiment will be omitted.

As illustrated in FIG. 18, the frame 160 is a member that extends in the Z direction and is in contact with the first side portion 121 at a portion between the first opening 101 and the bottom portion 110 to increase the mechanical strength of the first side portion 121.

The second opening 102 is formed in the first side portion 121 at a position that is near the center of the first side portion 121 and that is away from the bottom portion 110. On the other hand, in the second exemplary embodiment, the second opening 102 is, in the first side portion 121, formed near the bottom portion 110.

The frame 160 is formed so as to cover the second opening 102 provided in the first side portion 121. The frame 160 includes a fourth surface 160a in contact with the first side portion 121, a fifth surface 160b on a side opposite the fourth surface 160a, and sixth surfaces 160c and 160d that intersect the fourth surface 160a and the fifth surface 160b. The sixth surface 160c is disposed in the −Y direction, and the sixth surface 160d is disposed in the +Y direction.

A hole 161 that is an example of the first hole is formed in the frame 160. The hole 161 includes a portion that penetrates through the center of the frame 160 in the Z direction, and a portion that is in communication with the second opening 102 at a portion near the center of the portion penetrating the frame 160 in the Z direction. The hole 161 is in communication with the second opening 102.

In the hole 161, since the portion in communication with the second opening 102 is small compared with the portion that penetrates the center of the frame 160 in the Z direction, it can be deemed that the hole 161 is practically configured of the portion that penetrates the center of the frame 160 in the Z direction. Accordingly, the hole 161 can be deemed to extend in the direction (the Z direction) in which the frame 160 extends and to be in communication with the second opening 102.

A first end (an end in the +Z direction) of the portion in the hole 161 that penetrates the center of the frame 160 in the Z direction is disposed on the first opening 101 side, and a second end (an end in the −Z direction) is in contact with the bottom portion 110 and is closed by the bottom portion 110.

Note that holes 162 and 163 described later are not shown in FIG. 18.

As illustrated in FIGS. 19 and 20, in addition to the hole 161 described above, the holes 162 that are each an example of a second hole, and the holes 163 that are each an example of the second hole are formed in the frame 160. In FIGS. 19 and 20, hatching is provided in the hole 161.

Each of the holes 162 and 163 extends in a direction (the Y direction) that intersects the direction in which the frame 160 extends, is in communication with the hole 161, and, further, is in communication with the second opening 102 through the hole 161.

The holes 162 are disposed between the hole 161 and the sixth surface 160c and are formed to penetrate through the sixth surface 160c. The plurality of holes 162 are formed in the Z direction. The holes 163 are disposed between the hole 161 and the sixth surface 160d and are formed to penetrate through the sixth surface 160d. The plurality of holes 163 are formed in the Z direction.

As a result, the gas in the space S1 outside the sixth surfaces 160c and 160d (the space S1 (see FIG. 2) that is outside the bag 280) can be suctioned through the holes 162 and 163, the hole 161, and the second opening 102.

Note that the holes 161, 162, and 163 are each an example of the flow portion according to the present application.

As described above, the present exemplary embodiment has a configuration in which the second opening 102 is covered by the frame 160, and the flow portions through which the gas is allowed to flow are the holes 161, 162, and 163 provided in the frame 160.

Furthermore, the present exemplary embodiment has a configuration in which the flow portions through which the gas is allowed to flow include the hole 161 that is in communication with the second opening 102 and the extends in the direction (the Z direction) in which the frame 160 extends, and the holes 162 and 163 that are in communication with the hole 161 and that each extend in the direction (the Y direction) that intersects the direction in which the frame 160 extends, and in which the gas inside the box 100 can be suctioned through the hole 161, and the holes 162 and 163.

Furthermore, the present exemplary embodiment has a configuration in which the frame 160 is in contact with the first side portion 121, and in which the holes 162 and 163 are formed so as to penetrate through the sixth surfaces 160c and 160d that intersect the fourth surface 160a, which is in contact with the first side portion 121, and the fifth surface 160b, which is on the side opposite the fourth surface 160a, of the frame 160.

In the present exemplary embodiment, the gas inside the box 100C (the gas in the space S1) can be suctioned through the plurality of holes 162 that penetrate through the sixth surface 160c of the frame 160, and through the plurality of holes 163 that penetrate through the sixth surface 160d of the frame 160. In other words, in the present exemplary embodiment, since the gas inside the box 100C can be suctioned through the plurality of suction openings (the holes 162 and 163), compared with when suction can be performed through a single suction opening (the second opening 102), a trouble such as, for example, the suction opening becoming blocked by the bag 280 does not easily occur, and the gas inside the box 100C can be suctioned in a stable manner.

In the present exemplary embodiment, since the holes 162 and 163 that allow suction of the gas inside the box 100C are formed in the sixth surfaces 160c and 160d that intersect the fourth surface 160a and the fifth surface 160b, compared with forming the holes in the fifth surface 160b, the holes are disposed away from the bag 280, and a trouble such as the holes being closed by the bag 280 does not easily occur, and the gas in the box 100C can be suctioned in a stable manner.

In a state in which the bag 280 is installed inside the box 100C, the fifth surface 160b of the frame 160 is disposed so as to oppose the bag 280 and is disposed closer to the bag 280 than the sixth surfaces 160c and 160d of the frame 160. When the bag 280 becomes expanded inside the box 100C, the bag 280 easily comes in contact with the fifth surface 160b and does not easily come in contact with the sixth surfaces 160c and 160d that intersect the fifth surface 160b.

If the suction openings (the holes 162 and 163) are formed in the fifth surface 160b, the bag 280 will come in contact with the fifth surface 160b and the bag 280 will close the suction openings (the holes 162 and 163) formed in the fifth surface 160b, and it will be difficult for the gas inside the box 100C to be suctioned.

When the suction openings (the holes 162 and 163) are formed in the sixth surfaces 160c and 160d that intersect the fifth surface 160b, the bag 280 does not easily come in contact with the sixth surfaces 160c and 160d; accordingly, the suction openings (the holes 162 and 163) formed in the sixth surfaces 160c and 160d are not easily closed by the bag 280, and the gas inside the box 100C can be suctioned in a stable manner.

When the gas inside the box 100C can be suctioned in a stable manner, the bag 280 tends to become expanded throughout the entire box 100C in a stable manner; accordingly, compared with when the bag 280 is not expanded throughout the entire box 100C in a stable manner, the volume of the bag 280 that can accommodate the unneeded substances is large and the bag 280 does not easily become filled up with the unneeded substances. As a result, excellent effects such as the bag 280 being replaced at a lower frequency, the downtime of the sheet manufacturing system 1 being shorter, and the productivity of the sheet manufacturing system 1 being improved can be obtained.

Note that the shapes of the boxes 100, 100A, 100B, and 100C in the exemplary embodiments are illustrated, as an example, as a rectangular parallelepiped; however, not limited to such a shape, any third dimensional housing shape such as, for example, a cube, a columnar shape, or a retinal cone is suffice.

Contents derived from the exemplary embodiments described above will be described below.

A powder collector including a box including a first opening configured to pass powder therethrough, a bottom portion disposed so as to oppose the first opening, and a side portion that intersects the first opening and the bottom portion, the box being configured to install a bag provided so as to be in communication with the first opening, a suction opening provided in the box, the suction opening being configured to suction a gas inside the box, a plurality of frames disposed in at least either one of the bottom portion and the side portion, and a flow portion configured to flow the gas therethrough, in which the flow portion is a gap formed between a primary frame among the plurality of frames and a secondary frame among the plurality of frames.

In a state in which the bag in communication with the first opening is installed in the box, when the gas in the space between the bag and the box (the gas inside the box) is suctioned through the suction opening, the pressure of the space between the bag and the box becomes negative and the bag becomes expanded inside the box. Furthermore, even when, due to the pressure difference with the outside, force that deforms the box is applied to the box, since the mechanical strength of the side portion and the bottom portion of the box is increased with the plurality of frames, the deformation of the box is suppressed.

In addition, even when the plurality of frames are disposed in the side portion and the bottom portion of the box, the gas is allowed to flow inside the box due to the gap provided between the primary frame and the secondary frame; accordingly, compared with when the gap is not provided, suction of the gas throughout the entire box (the entire space between the bag and the box) is facilitated, the bag is expanded throughout the box more easily, and the unevenness in expansion of the bag inside the box is suppressed.

A powder collector includes a box including a first opening configured to pass powder therethrough, a bottom portion disposed so as to oppose the first opening, and a side portion that intersects the first opening and the bottom portion, the box being configured to install a bag provided so as to be in communication with the first opening, a suction opening provided in the box, the suction opening being configured to suction a gas inside the box, a frame disposed in at least either one of the bottom portion and the side portion, in which a flow portion configured to flow the gas therethrough is formed in the frame.

In a state in which the bag in communication with the first opening is installed in the box, when the gas in the space between the bag and the box (the gas inside the box) is suctioned through the suction opening, the pressure of the space between the bag and the box becomes negative and the bag becomes expanded inside the box. Furthermore, even when, due to the pressure difference with the outside, force that deforms the box is applied to the box, since the mechanical strength of the side portion and the bottom portion of the box is increased with the frame, the deformation of the box is suppressed.

In addition, even when the frame is disposed in the side portion and the bottom portion, since the flow portion configured to allow the gas to flow therethrough is formed in the frame, compared with when the flow portion is not formed in the frame, suction of the gas throughout the entire box (the entire space between the bag and the box) is facilitated, the bag is expanded throughout the box more easily, and the unevenness in expansion of the bag inside the box is suppressed.

In the powder collector described above, desirably, the frame includes a tertiary frame in contact with the bottom portion, and the flow portion is a groove that extends in a direction that intersects a direction in which the tertiary frame extends, the groove being formed in at least one of a first surface of the tertiary frame in contact with the bottom portion, a second surface of the tertiary frame on a side opposite the first surface, and a third surface of the tertiary frame that intersects the first surface and the second surface.

When the groove is provided in at least one of the first surface, the second surface, and the third surface of the tertiary frame, the gas inside the box is allowed to flow through the groove; accordingly, even when the tertiary frame is disposed in the side portion and the bottom portion of the box, the flow of the gas inside the box is not easily inhibited by the tertiary frame, and the gas inside the box is suctioned in a uniform manner.

In the powder collector described above, desirably, the frame includes a quaternary frame in contact with the side portion, and the flow portion is a groove that extends in a direction that intersects a direction in which the quaternary frame extends, the groove being formed in at least one of a fourth surface of the quaternary frame in contact with the side portion, a fifth surface of the quaternary frame on a side opposite the fourth surface, and a sixth surface of the quaternary frame that intersects the fourth surface and the fifth surface.

When the groove is provided in at least one of the fourth surface, the fifth surface, and the sixth surface of the quaternary frame, the gas inside the box is allowed to flow through the groove; accordingly, even when the quaternary frame is disposed in the side portion and the bottom portion of the box, the flow of the gas inside the box is not easily inhibited by the quaternary frame, and the gas inside the box is suctioned in a uniform manner.

In the powder collector described above, desirably, the flow portion is a hole that penetrates through the frame.

When the hole that penetrates through the frame is provided, the gas inside the box is allowed to flow through the hole; accordingly, even when the frame is disposed in the side portion and the bottom portion of the box, the flow of the gas inside the box is not easily inhibited by the frame, and the gas inside the box is suctioned in a uniform manner.

In the powder collector described above, desirably, the suction opening is covered by a frame of the plurality of frames, and the flow portion is a hole provided in the frame.

When the suction opening is covered with the frame, when the hole is provided in the frame, and when the suction opening and the hole are made to be in communication with each other, the gas inside the box will be allowed to be suctioned through the hole. For example, if there is a portion in the box where the gas is not easily suctioned, by disposing the frame in the portion where the gas is not easily suctioned, the gas in the portion where the gas is not easily suctioned is suctioned more easily.

In the powder collector described above, desirably, the flow portion includes a first hole in communication with the suction opening, the first hole extending in a direction in which the frame extends, and a second hole in communication with the first hole, the second hole extending in a direction that intersects the direction in which the frame extends, and the gas inside the box is suctionable through the first hole and the second hole.

The second hole is a second suction opening that branches off from the first hole. The gas inside the box becomes suctionable through the first hole and the second hole (the second suction opening). For example, if there is a portion in the box where the gas is not easily suctioned, by disposing the second hole in the portion where the gas is not easily suctioned, the gas in the portion where the gas is not easily suctioned is suctioned more easily. For example, when a plurality of second suction openings (the second holes) that branch off from the first hole are provided, since the number of suction openings through which the gas is suctioned becomes large, the gas inside the box can be suctioned in a uniform manner compared with when the number of suction openings through which the gas is suctioned is small.

In the powder collector described above, desirably, the frame is in contact with the bottom portion, and the second hole is formed so as to penetrate through a third surface that intersects a first surface of the frame, the first surface being in contact with the bottom portion, and a second surface on a side opposite the first surface.

When the bag is installed inside the box, the second surface is disposed so as to oppose the bag, and the third surface is disposed away from the bag compared with the second surface. When the second hole is provided to penetrate through the third surface disposed away from the bag, compared with providing the second hole to penetrate through the second surface disposed so as to oppose the bag, the bag does not easily come in contact with the third surface and a shortcoming such as the bag closing the second hole penetrating the third surface does not easily occur.

In the powder collector described above, desirably, the frame is in contact with the side portion, and the second hole is formed so as to penetrate through a sixth surface that intersects a fourth surface of the frame, the fourth surface being in contact with the side portion, and a fifth surface on a side opposite the fourth surface.

When the bag is installed inside the box, the fifth surface is disposed so as to oppose the bag, and the sixth surface is disposed away from the bag compared with the fifth surface. When the second hole is provided to penetrate through the sixth surface disposed away from the bag, compared with providing the second hole to penetrate through the fifth surface disposed so as to oppose the bag, the bag does not easily come in contact with the sixth surface and a shortcoming such as the bag closing the second hole penetrating the sixth surface does not easily occur.

What is claimed is:

1. A powder collector comprising:
a box including a first opening configured to pass powder therethrough, a bottom portion disposed so as to oppose the first opening, and a side portion that intersects the first opening and the bottom portion, the box being configured to install a bag provided so as to be in communication with the first opening;
a suction opening provided in the box, the suction opening being configured to suction a gas inside the box;
a plurality of frames disposed in at least either one of the bottom portion and the side portion; and
a flow portion configured to flow the gas therethrough, wherein
the flow portion is a gap formed between a primary frame among the plurality of frames and a secondary frame among the plurality of frames.

2. A powder collector comprising:
a box including a first opening configured to pass powder therethrough, a bottom portion disposed so as to oppose the first opening, and a side portion that intersects the first opening and the bottom portion, the box being configured to install a bag provided so as to be in communication with the first opening;
a suction opening provided in the box, the suction opening being configured to suction a gas inside the box;
a frame disposed in at least either one of the bottom portion and the side portion, wherein
a flow portion configured to flow the gas therethrough is formed in the frame.

3. The powder collector according to claim 2, wherein
the frame includes a tertiary frame in contact with the bottom portion, and
the flow portion is a groove that extends in a direction that intersects a direction in which the tertiary frame extends, the groove being formed in at least one of a first surface of the tertiary frame in contact with the bottom portion, a second surface of the tertiary frame on a side opposite the first surface, and a third surface of the tertiary frame that intersects the first surface and the second surface.

4. The powder collector according to claim 2, wherein
the frame includes a quaternary frame in contact with the side portion, and
the flow portion is a groove that extends in a direction that intersects a direction in which the quaternary frame extends, the groove being formed in at least one of a fourth surface of the quaternary frame in contact with the side portion, a fifth surface of the quaternary frame on a side opposite the fourth surface, and a sixth surface of the quaternary frame that intersects the fourth surface and the fifth surface.

5. The powder collector according to claim 2, wherein
the flow portion is a hole that penetrates through the frame.

6. The powder collector according to claim 1, wherein
the suction opening is covered by a frame of the plurality of frames, and
the flow portion is a hole provided in the frame.

7. The powder collector according to claim 2, wherein
the flow portion includes,
a first hole in communication with the suction opening, the first hole extending in a direction in which the frame extends, and
a second hole in communication with the first hole, the second hole extending in a direction that intersects the direction in which the frame extends, and
the gas inside the box is suctionable through the first hole and the second hole.

8. The powder collector according to claim 7, wherein
the frame is in contact with the bottom portion, and the second hole is formed so as to penetrate through a third surface that intersects a first surface of the frame, the first surface being in contact with the bottom portion, and a second surface on a side opposite the first surface.

9. The powder collector according to claim 7, wherein
the frame is in contact with the side portion, and the second hole is formed so as to penetrate through a sixth surface that intersects a fourth surface of the frame, the fourth surface being in contact with the side portion, and a fifth surface on a side opposite the fourth surface.
